(19) United States
(12) Patent Application Publication
(10) Pub. No.: US 2006/0080361 A1
(43) Pub. Date: Apr. 13, 2006

(54) Document information processing apparatus, document information processing method, and document information processing program

(76) Inventors: Masaru Suzuki, Kanagawa-ken (JP); Yasuto Ishitani, Chiba-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/230,581

(22) Filed: Sep. 21, 2005

(30) Foreign Application Priority Data
Sep. 21, 2004 (JP) 2004-273511

(51) Int. Cl. G06F 17/00

(52) U.S. Cl. 707/104.1

(57) ABSTRACT

Apparatus and methods are provided for processing document information. In accordance with one implementation, a document information processing apparatus includes a document analysis means for conducting document analysis of document information inputted from document information input means using document analysis knowledge; a componentization means for dividing the document information, inputted from the document information input means, into information components which are units of editing; an indexing means for generating index information for and assigning the index information to the information components based on results of the document analysis; and information component storage means for associatively storing the information components and the index information assigned to these information components. The apparatus may also include information component retrieval means for retrieving the information components.

### CROSS-REFERENCE TO RELATED APPLICATIONS

This application is based upon and claims the benefit of priority from prior Japanese Patent Application No. 2004-273511, filed Sep. 21, 2004, the entire contents of which are incorporated herein by reference.

### BACKGROUND OF THE INVENTION

1. Field of the Invention

This invention relates to a document information processing apparatus, a document information processing method, and a document information processing program which retrieve/edit the electronic information of Internet contents, electronic mail, etc., or electronic information extracted from a print medium, such as paper, by an Optical Character Reader (OCR) or similar technology. More particularly, it relates to a document information processing apparatus which supports or automates the action of turning electronic information into a plurality of components, the action of retrieving/acquiring the componentized information, or the action of editing the acquired components and producing new contents.

2. Description of the Related Art

With the growing popularity of the Internet and the performance enhancements and widespread use of digital cameras, scanners, etc., general users have come to browse a variety of and large amounts of information items on personal computers in both business/home uses. Needs have consequently increased for preserving as scraps, those information items of the browsed information items which the user has judged useful, or some of the information items.

As a prior art technique complying with the needs, application software which can directly scrap contents being browsed, such as “OneNote™” (produced by Microsoft Corporation) or “kami-copi™” (produced by YMIRLINK Inc.) is commercially available. A method has been proposed for editing a structuralized document whose componential structure is defined (refer to, for example, Patent Document 1), a method for programmably templating the layout of information items to-be-browsed in an imaging system for medical use (refer to, for example, Patent Document 2) and so forth.

Patent Document 1: JP-A-2002-200284

Patent Document 2: JP-A-09-217474

With the prior art techniques, however, each component of a scrap cannot be given semantic or syntactic information (for example, the format of the information (called “source information”) from which the scrap has originated, the functional role of the component in the source information, or the semantic attributes of individual elements contained in the component). It is therefore impossible to increase the efficiency of the scrapping operation, or the reuse of the contents produced by the scrapping operation (hereinafter “scrap pages”). More specifically, in a case where, as to scrap pages collected for a certain purpose, scraps of the same role are thereafter to be acquired from source information of the same format without requiring much labor, or in a case where scrapped information items have been arranged into scrap pages of certain format, there is the problem that needs for thereafter producing scrap pages in the same format cannot be complied with.

### BRIEF SUMMARY OF THE INVENTION

An objective of the present invention is to provide a document information processing apparatus which can accurately obtain necessary information.

Consistent with the present invention, there is provided a document information processing apparatus comprising document information input means for inputting document information; document analysis means for conducting a document analysis of the document information by using analytical knowledge for analyzing the document information; componentization means for dividing the document information into information components which are units of editing; indexing means for generating index information for the information components and assigning the index information to the information components, based on results of the document analysis; and information component storage means for associatively storing the information components and the index information assigned to the information components.

Consistent with the present invention, there is also provided a document information processing apparatus comprising document information input means for inputting document information; document analysis means for conducting a document analysis of the document information by using analytical knowledge for analyzing the document information; componentization means for dividing the document information into information components which are units of editing; information component selection means for allowing a user to select the information components; indexing means for generating index information for the information components and for assigning the index information to the information components based on results of the user selection; and information component storage means for associatively storing the information components and the index information assigned to the information components.

Consistent with the present invention, there is further provided a document processing method comprising inputting document information; conducting a document analysis of the inputted document information by using analytical knowledge for analyzing the document information; dividing the inputted document information into information components which are units of editing; generating index information for the information components and assigning the index information to the information components based on results of the document analysis; and associatively storing the information components and the index information assigned to the information components, as sets in information component storage means.

Consistent with the present invention, there is additionally provided a document processing method comprising inputting document information; conducting a document analysis of the inputted document information by using analytical knowledge for analyzing the document information; dividing the inputted document information into information components which are units of editing; allowing a user to select the divided information components; generating index information for the information components and assigning the index information to the information components based on results of the user selection; and associatively storing the information components and the index information assigned to the information components, as sets in information component storage means.

Consistent with the present invention, there is yet further provided a computer-readable medium containing instruction for performing a method for processing document information, the method comprising inputting document information; conducting a document analysis of the inputted document information by using analytical knowledge for analyzing the document information; dividing the inputted document information into information components that are units of editing; generating index information for the information components and assign the index information to the information components based on results of the document analysis; and associatively storing the information components and the index information assigned to the information components, as sets in information component storage means.

Consistent with the present invention, there is also provided a computer-readable medium containing instructions for performing a method for processing document information, the method comprising inputting document information; conducting a document analysis of the inputted document information by using analytical knowledge for analyzing the document information; dividing the inputted document information into information components which are units of editing; allowing a user to select the divided information components; generating index information for the information components and assigning the index information to the information components based on results of the user selection; and associatively storing the information components and the index information assigned to the information components, as sets in information component storage means.

According to embodiments of the present invention, it is possible to provide a document information processing apparatus which can perform appropriate indexing based upon the context of document data.

### BRIEF DESCRIPTION OF THE DRAWINGS

FIG. 1 is a block diagram of an exemplary document information processing apparatus according to a first embodiment of this invention;

FIGS. 2A-2D are diagrams showing examples of information items which are inputted to an information input means;

FIGS. 3A-3C are diagrams showing examples of sources of the information items which are inputted to the information input means;

FIG. 4 is a flow chart for explaining the flow of the processing of a document analysis means;

FIGS. 5A and 5B are diagrams each showing an example of knowledge which concerns a document structure analysis;

FIG. 6 is a flow chart for explaining a document structure analysis process in a case where information described in HTML has been inputted;

FIGS. 7A-7D are diagrams each showing an example of the result of the document structure analysis process by the document analysis means;

FIG. 8A is a diagram showing an example of the result of a semantic attribute analysis process by the document analysis means (output example in the case where the information in FIG. 3A has been inputted);

FIG. 8B is a diagram showing an example of the result of the semantic attribute analysis process by the document analysis means (output example in the case where the information in FIG. 3B has been inputted);

FIG. 8C is a diagram showing an example of the result of the semantic attribute analysis process by the document analysis means (output example in the case where the information in FIG. 3C has been inputted);

FIG. 8D is a diagram showing an example of the result of the semantic attribute analysis process by the document analysis means (output example in the case where the information in FIG. 2D has been inputted);

FIG. 9 is a flow chart for explaining a functional role analysis process by the document analysis means;

FIG. 10 is a diagram showing examples of functional role analysis knowledge;

FIG. 11A is a diagram showing an example of the processed result of the functional role analysis process for the document data in FIG. 8A;

FIG. 11B is a diagram showing an example of the processed result of the functional role analysis process for the document data in FIG. 8B;

FIG. 11C is a diagram showing an example of the processed result of the functional role analysis process for the document data in FIG. 8C;

FIG. 11D is a diagram showing an example of the processed result of the functional role analysis process for the document data in FIG. 8D;

FIG. 12 is a flow chart for explaining the flow of the processing of a componentization means;

FIG. 13A is a diagram showing an example of the processed result of the componentization means in the case where the document data in FIG. 11A have been inputted;

FIG. 13B is a diagram showing an example of the processed result of the componentization means in the case where the document data in FIG. 11B have been inputted;

FIG. 13C is a diagram showing an example of the processed result of the componentization means in the case where the document data in FIG. 11C have been inputted;

FIG. 13D is a diagram showing an example of the processed result of the componentization means in the case where the document data in FIG. 11D have been inputted;

FIG. 14 is a flow chart for explaining the flow of the processing of an indexing means;

FIG. 15 is a diagram showing the construction of the indexing means;

FIG. 16 is a diagram showing the construction of an information component storage means;

FIGS. 17A and 17B are diagrams showing examples of indexing strategy knowledge;

FIG. 18 is a flow chart for explaining the flow of processing of a retrieval means;

FIG. 19 is a diagram showing the construction of the retrieval means;

FIG. 20 is a diagram showing examples of retrieval strategy knowledge;

FIG. 21 is a diagram showing the construction of a document information processing apparatus according to a second embodiment;

FIG. 22 is a diagram showing examples of the screen of an editing job which employs an edit means;

FIGS. 23A and 23B are diagrams showing examples of the data representations of a scrapbook;

FIG. 24 is a flow chart for explaining the operation of a template generation means;

FIG. 25 is a diagram showing an example of a template which has been converted from FIG. 23B by the template generation means;

FIG. 26 is a flow chart for explaining the flow of processing in the case where the edit means executes an edit process on the basis of a template;

FIGS. 27A and 27B are diagrams showing a group of documents;

FIGS. 28A and 28B are diagrams showing an edited result in the case where parts indicated in FIG. 25 have been both substituted; and

FIG. 29 shows a diagram depicting an exemplary hardware architecture in which systems and methods consistent with the present invention may be implemented.

### DETAILED DESCRIPTION OF THE INVENTION

Embodiments of the present invention will be described below with reference to the accompanying drawings.

### First Embodiment

The first embodiment includes a document information processing apparatus which can divide and componentized contents browsed on a PC by a user, for example, contents on the Internet or electronic mail, or paper medium contents turned into electronic text by employing a scanner and an OCR, and which permits the user to retrieve and edit the componentized information as needed.

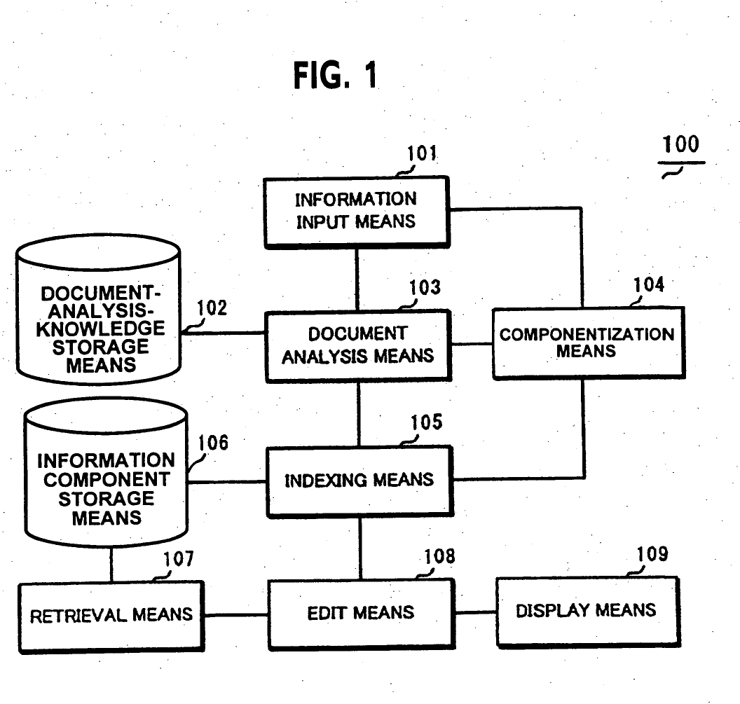

FIG. 1 is a diagram showing an exemplary document information processing apparatus according to the first embodiment of this invention.

Referring to FIG. 1, a document information processing apparatus 100 includes an information input means 101, a document-analysis-knowledge storage means 102, a document analysis means 103, a componentization means 104, an indexing means 105, an information component storage means 106, and a retrieval means 107.

Information input means 101 reads out information being browsed by the user, as inputs to document information processing apparatus 100. In the first embodiment, the information to be extracted may be the contents on the Internet, the electronic mail, and the electronic information which has been obtained in such a way that information printed on paper or the like is loaded by the scanner and is converted thereinto by existing OCR (Optical Character Reader) technology. More specifically, information input means 101 communicates with application software by which the user is browsing such information items, thereby to extract the information. The application software serving as the information extractor may be either a program created exclusively for this embodiment, or any existing application software. In case of the existing application software, the information may be extracted by the communication technology between existing application software products.

Document-analysis-knowledge storage means 102 stores therein document analysis knowledge for analyzing the document information inputted to information input means 101. By way of example, semantic analysis knowledge for the semantic analysis of the document information is stored as the document analysis knowledge.

Document analysis means 103 analyzes the document information inputted to information input means 101, on the basis of the document analysis knowledge stored in document-analysis-knowledge storage means 102. The analysis is, for example, the semantic analysis.

Componentization means 104 divides and componentizes the information inputted to information input means 101, on the basis of the document analysis result of document analysis means 103. Items obtained by dividing and componentizing the information shall be termed “information components” below.

Indexing means 105 generates and assigns indexes to the individual information components divided by componentization means 104 on the basis of the document analysis result of document analysis means 103, and stores the resulting information components in information component storage means 106.

Information component storage means 106 stores therein the information components endowed with the indexes by indexing means 105.

Retrieval means 107 retrieves the information components stored in information component storage means 106, on the basis of the indexes.

An edit means 108 edits new contents by utilizing at least one of the information components retrieved by the retrieval means 107. The contents edited by edit means 108 are sent to indexing means 105, and they are endowed with indexes as new information components and are stored in information component storage means 106.

An edit screen based on edit means 108 is displayed on a display means 109 such as a CRT (Cathode-Ray Tube) display or a liquid crystal display (LCD).

Now, the operation of document information processing apparatus 100 will be described using sample information.

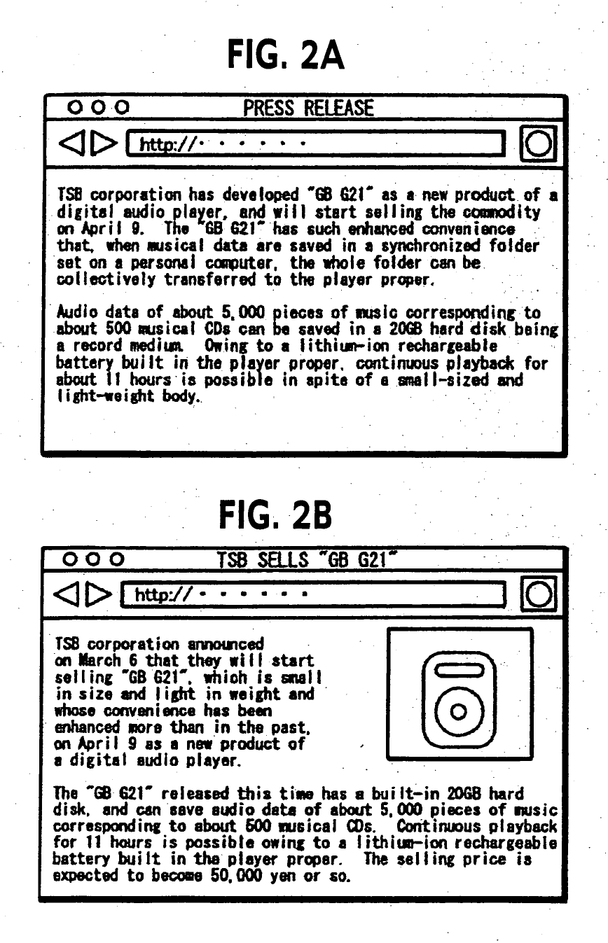

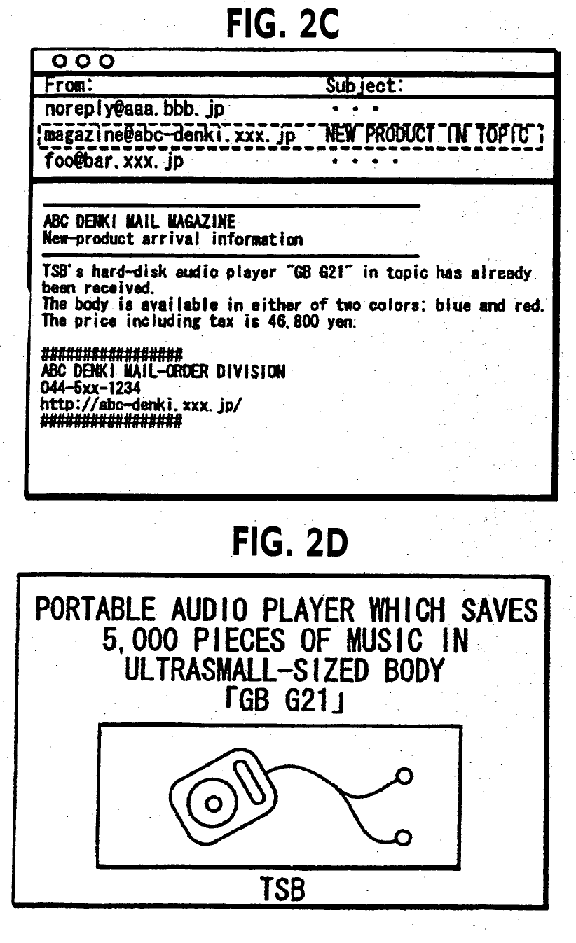

FIGS. 2A-2D are diagrams showing examples of the information items which are inputted to information input means 101.

All the examples in FIGS. 2A-2D are the information items on the product “GB G21” of TSB corporation.

FIG. 2A shows the Web contents of the press release of the product by TSB corporation (data written in the HTML (Hyper Text Markup Language) format), FIG. 2B shows the Web contents (HTML) of a product introducing account which appears in a news site on the Internet, FIG. 2C shows the direct mail of electronic mail from a store (a text with a mail header), and FIG. 2D shows a catalogue (the data of the catalogue printed on a paper medium as loaded by a scanner).

The electronic information items shown in FIGS. 2A and 2B are inputted from a Web browser for the Internet to the information input means 101. The electronic information shown in FIG. 2C is inputted from an electronic mail application to the information input means 101. The electronic information shown in FIG. 2D is inputted from a browser for image scan data to information input means 101.

In an embodiment consistent with the present invention in which the document information processing apparatus 100 is implemented as an application software in which the functions of the Web browser and the electronic-mail application software are incorporated as software components, the information input means 101 may accept the inputs of the information items via the Application Programming Interface (API) of the software components. In another embodiment consistent with the present invention in which the document information processing apparatus 100 is implemented as an application software that operates in collaboration with an external software (e.g., Web browser, electronic-mail application software, etc.), information input means 101 accepts the inputs of the information items by communicating on the basis of the communication technology between the external software and the application software.

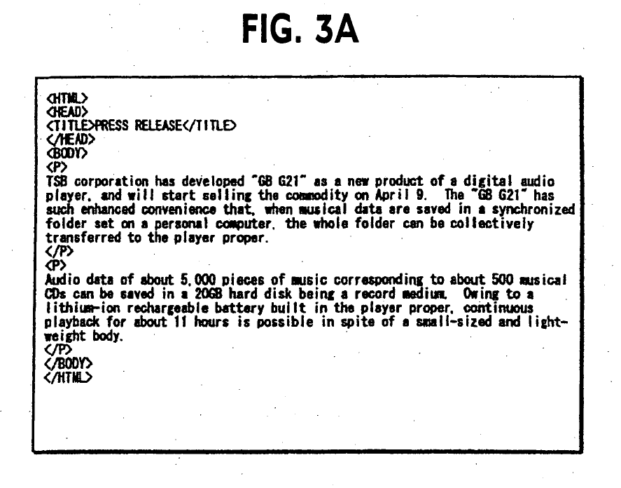

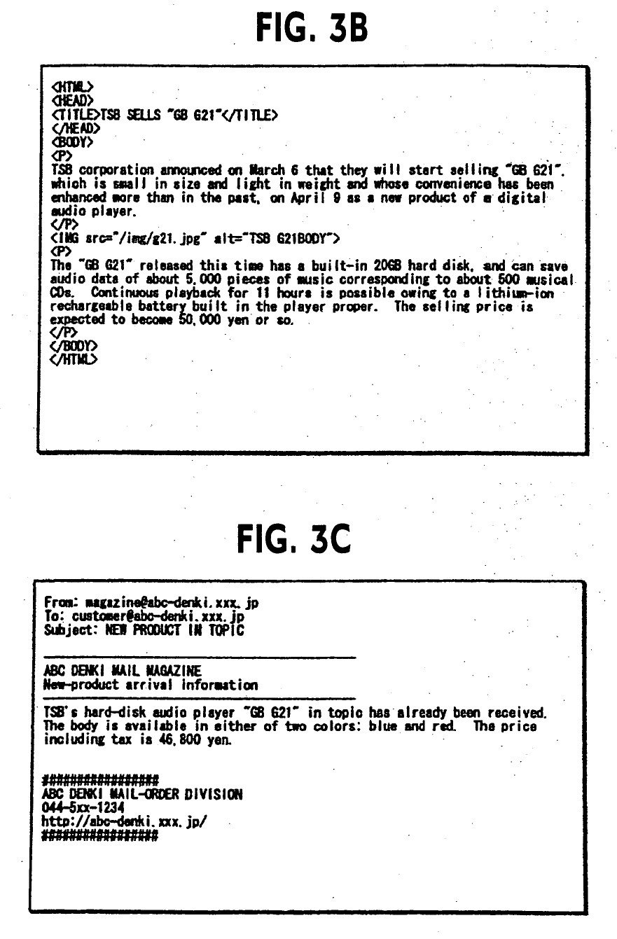

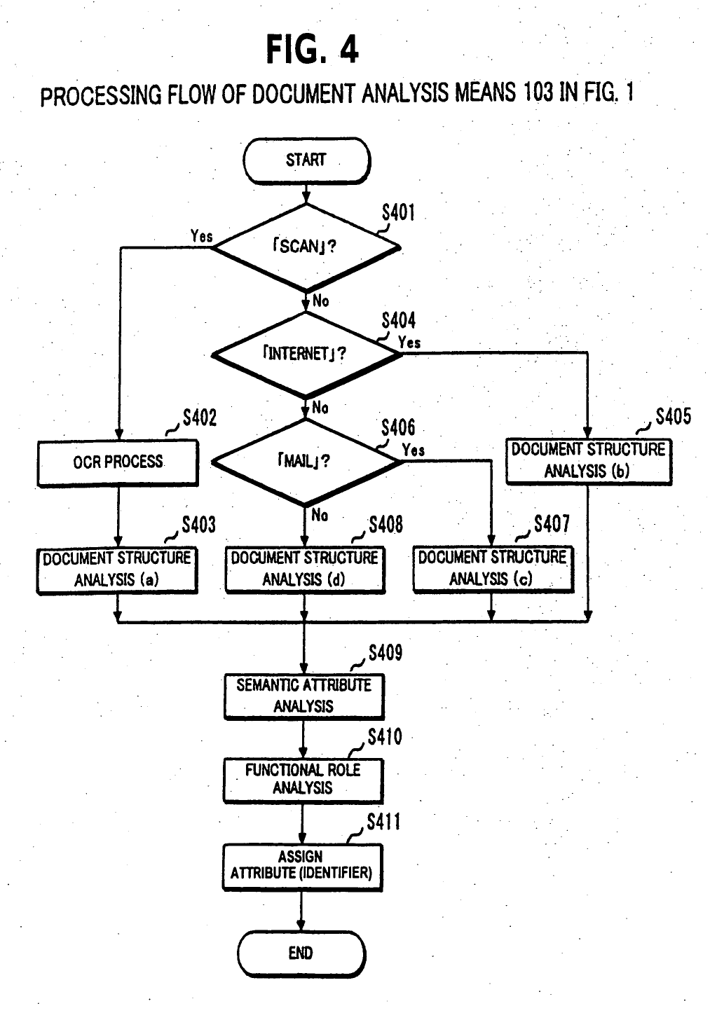

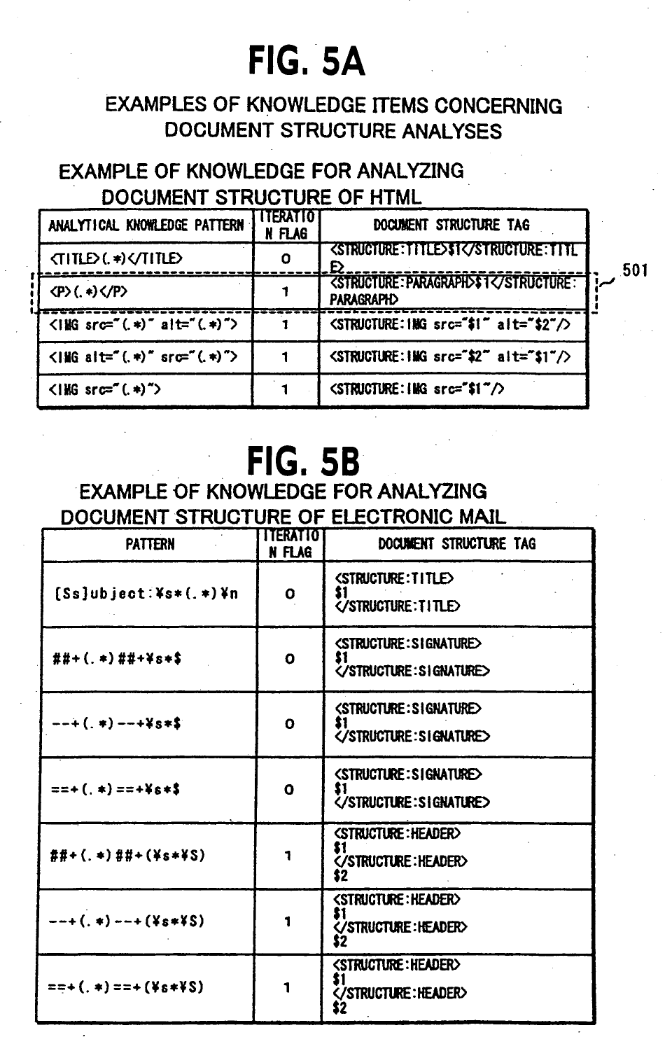

FIGS. 2A and 2B exemplify the cases where the information items have been browsed by the Web browser, and examples of the sources of the information items which are actually inputted to information input means 101 are respectively shown in FIGS. 3A and 3B. Likewise, FIG. 2C exemplifies the case where the information has been browsed by the electronic-mail application software, and an example of the source of the information which is actually inputted to information input means 101 is shown in FIG. 3C. FIG. 2D exemplifies the case where the information has been browsed by a browser for the image scan data, and the information is inputted to information input means 101 as binary data in an image data format such as Tag Image File Format (TIFF).

Information input means 101 affixes the type or identifier of the input source of the information as attribute information to the inputted information, and sends the resulting information to document analysis means 103. That “type or identifier of the input source of the information which is affixed as the attribute information” is attribute information for identifying the Web browser or electronic-mail application software, or the software component having the function thereof with which information input means 101 has communicated in order to accept the input of the information.

Here, it is assumed by way of example that the identifier of the Web browser or the software component thereof be “INTERNET”. Also, the identifier of the electronic-mail application software or the software component thereof is assumed to be “MAIL”. Moreover, the identifier of the browser for the image scan data or the software component thereof is assumed to be “SCAN”.

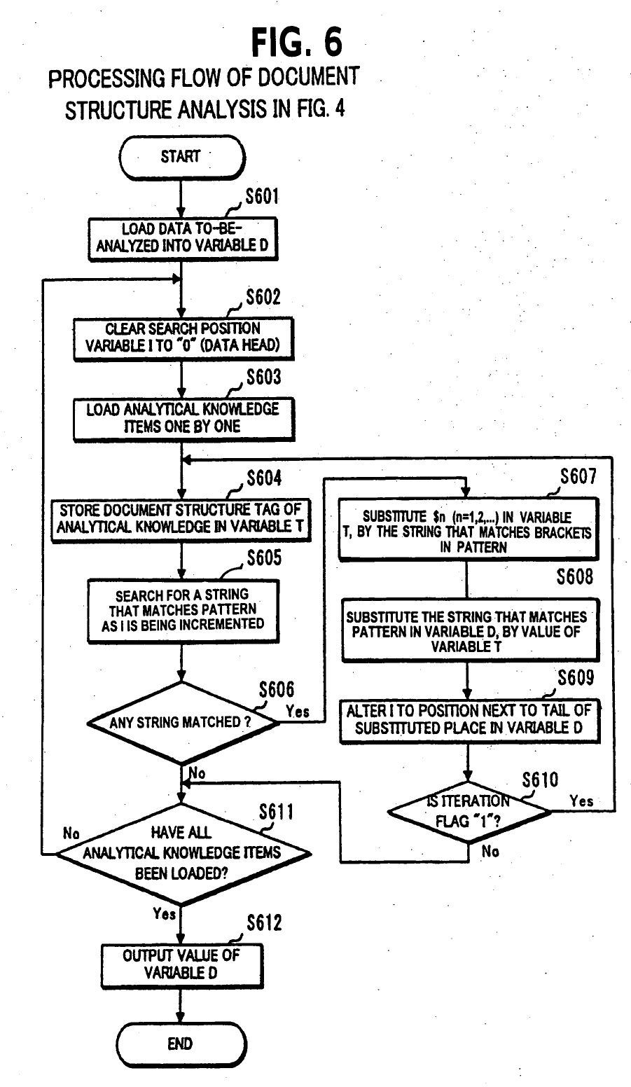

Document analysis means 103 makes document analyses on the document structure of the inputted information, the functional role of a part contained in the inputted information, and the semantic attribute of a word, a clause or a sentence contained in the inputted information. The processing of document analysis means 103 will be described in conjunction with FIG. 4.

Next, the flow of the processing of document analysis means 103 will be described with reference to the flow chart of FIG. 4.

Referring to FIG. 4, document analysis means 103 changes over the analytical process of a document structure in accordance with attribute information inputted from information input means 101 (step S401, step S404 or step S406).

Document analysis means 103 judges whether or not the attribute information inputted from information input means 101 is “SCAN” (step S401).

In a case where the judgment at step S401 is “Yes”, the inputted information is image scan data. Therefore, document analysis means 103 first executes an OCR process so as to convert the image scan data into text (step S402) and subsequently subjects the text to a document structure analysis process (a) (step S403).

The OCR process for the image scan data, and the document structure analysis process (a) are possible with a known technique (in, for example, JP-A-2003-288334), and they shall be omitted from detailed description here.

On the other hand, in a case where the judgment at step S401 is “No”, document analysis means 103 judges whether or not the attribute information inputted from information input means 101 is “INTERNET” (step S404).

In a case where the judgment at step S404 is “Yes”, the inputted information is described in HTML. Therefore, document analysis means 103 executes a document structure analysis process (b) in which the structure of the HTML is taken into consideration (step S405). The details of the document structure analysis process (b) will be described later.

On the other hand, in a case where the judgment at step S404 is “No”, document analysis means 103 judges whether or not the attribute information inputted from information input means 101 is “MAIL” (step S406).

In a case where the judgment at step S406 is “Yes”, it is considered that the inputted information will bear an electronic mail header. Therefore, document analysis means 103 executes a document structure analysis process (c) in which the electronic mail header is taken into consideration (step S407). The document structure analysis process (c) will be described in detail later.

In a case where the judgment at step S406 is “No”, that is, where the attribute information inputted from information input means 101 is none of the identifiers “SCAN”, “INTERNET” and “MAIL” (the judgments are “No” at steps S401, S404 and S406), document analysis means 103 executes a document structure analysis process (d) under the assumption that the inputted information is described in a plain text (step S408).

Although only the cases of the identifiers “SCAN”, “INTERNET” and “MAIL” are supposed as the attribute information in this example, processes may well be similarly executed for other identifiers.

After the document structure analysis process (a) at step S403, document structure analysis process (b) at step S405, document structure analysis process (c) at step S407 or document structure analysis process (d) at step S408, document analysis means 103 executes a semantic attribute analysis process (step S409), it further executes a functional role analysis process (step S410), and it finally assigns the attribute information sent from information input means 101 (step S411), whereby a semantic analysis result is outputted.

While the processing in FIG. 4 has been performed in the order of the document structure analysis process (step S403, S405, S407 or S408), semantic attribute analysis process (step S409) and functional role analysis process (step S410), the sequence of these processes need not be restricted in any of the embodiments of this invention. Moreover, if necessary, at least one of these processes may well be selectively executed.

The processing contents of the document structure analysis processes (b)-(d) by document analysis means 103 will be described.

In order to conduct the analyses of the-document structure analysis processes (b)-(d), document analysis means 103 refers to knowledge items concerning the document structure analyses, among the document analysis knowledge stored in document analysis knowledge storage means 102.

Examples of the knowledge items concerning the document structure analyses are shown in FIGS. 5A and 5B.

FIG. 5A exemplifies the knowledge for analyzing the document structure of HTML.

FIG. 5B exemplifies the knowledge for analyzing the document structure of the electronic mail or the plain text. The knowledge items for analyzing the document structures of the electronic mail and the plain text need not always be identical.

In this embodiment, the difference between the document structure analysis process (b) (or (c) and that (d) is incarnated by referring to the document analysis knowledge items which are different from each other. That is, the document structure analysis processes (b)-(d) refer to the knowledge items in FIGS. 5A and 5B in accordance with a common processing flow shown in FIG. 6, respectively.

[Operation of Document Structure Analysis Process (b)]

First, the operation of the document structure analysis process (b) in the case where the information described in HTML as shown in FIG. 3A has been inputted will be described with reference to FIG. 6.

The information in FIG. 3A is described in HTML, and the analytical process (b) refers to the knowledge in FIG. 5A.

Document analysis means 103 loads the document information in FIG. 3A as data to-be-analyzed, and puts the loaded information into a variable D (step S601).

Next, document analysis means 103 clears to “0”, a variable I which represents the position of pattern matching (the position of a character from the head of a document includes a line feed character) (step S602).

Subsequently, document analysis means 103 fetches one analytical knowledge item from the document structure analysis knowledge stored in document analysis knowledge storage means 102 (step S603). Here, it is assumed that an analytical knowledge item 501 shown as an example in FIG. 5A has been fetched.

In order to perform a substitution process later, document analysis means 103 puts into a variable T, “<STRUCTURE:TITLE>$1</STRUCTURE:TITLE>” being a “document structure tag” within analytical knowledge 501 fetched at step S603 (step S604).

Regarding the data to-be-analyzed stored in variable D, document analysis means 103 searches for a place which matches with the “pattern” of analytical knowledge 501, from the position indicated by variable I (step S605).

In this embodiment, the format of a normal representation which is utilized in known technology called “Perl language” is adopted as the pattern. The Perl language and the normal representation of this language are known from, for example, a document “Learning Perl, 2nd Edition”, Randal L. Schwartz & Tom Christiansen (O'Reilly 1997), the entire contents of this reference being incorporated herein by reference.

In the case of pattern of analytical knowledge 501 in FIG. 5A, the data to-be-analyzed matches in a case where any character (.) of at least 0 character (*) exists between character strings “<TITLE>” and “</TITLE>”. Here, the line feed character shall be also included in any character (.). Furthermore, in a case where the character string “</TITLE>” occurs multiple times in the inputted information, the shortest one of the matching character strings shall be selected here. Finally, the part “<TITLE>-</TITLE>” occurring first in a sentence is selected.

Document analysis means 103 judges whether or not the string matching with the pattern has been found as the result of the search at step S605 (step S606).

In a case where the judgment at step S606 is “Yes”, document analysis means 103 substitutes “$n(n=1, 2, . . . ) in variable T” by a character string which corresponds to brackets existing in the pattern (step S607). In a case where at least two brackets exist corresponds to at least two “n” in variable T. Using the document data in FIG. 3A as an example, “<TITLE>PRESS RELEASE</TITLE>” at the third line matches with the pattern, and a character string “PRESS RELEASE” corresponds to the brackets in the pattern, so that the value of variable T is altered to “<STRUCTURE:TITLE>PRESS RELEASE</STRUCTURE:TITLE>. The value of variable I representative of the position on this occasion is “15” including line feed characters. In other words, that character next to “<HTML>[line feed character]<HEAD>[line feed character]” (the “[line feed character]” being actually one character) which is the 15th character counted from the head matches with the pattern.

On the other hand, in a case where the judgment at step S606 is “No”, document analysis means 103 proceeds to step S611.

Subsequently to step S607, document analysis means 103 substitutes the string “<TITLE>PRESS RELEASE</TITLE>” in variable D, by the value “<STRUCTURE:TITLE>PRESS RELEASE</STRUCTURE:TITLE>” of variable T (step S608).

Document analysis means 103 alters the value of variable I representative of the position, to a position next to the tail of the substituted place in variable D (step S609). Here, I=41 is set. In other words, that character next to “<HTML>[line feed character]<HEAD>[line feed character]<STRUCTURE:TITLE>PRESS RELEASE</STRUCTURE:TITLE>” which is the 41st character as counted from the head is set.

Following step S609, document analysis means 103 judges whether or not the value of the “iteration flag” of the analytical knowledge being processed is “1” (step S610).

Subject to “Yes” at step S610, document analysis means 103 iterates the processing at steps S604 through S606 again for the identical analytical knowledge until the matching with the pattern fails. On the other hand, subject to “No” at step S610, document analysis means 103 proceeds to step S611.

The processing of steps S602-S610 is iteratively executed for all the corresponding analytical knowledge items (step S611). When the processing has been completed for all the corresponding analytical knowledge items (“Yes” at step S611), variable D is outputted as an analytical result (step S612). Then, the processing flow in FIG. 6 is ended.

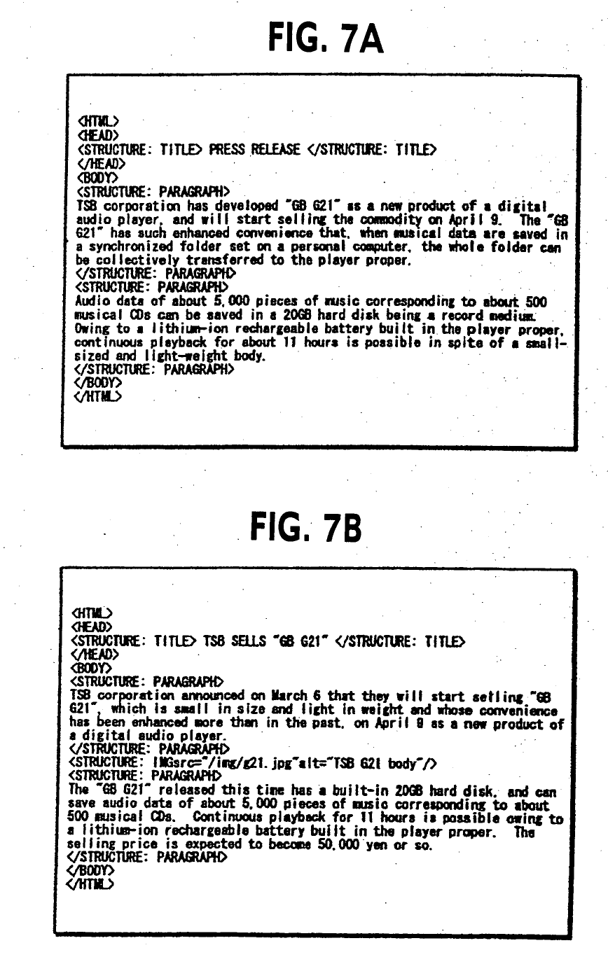

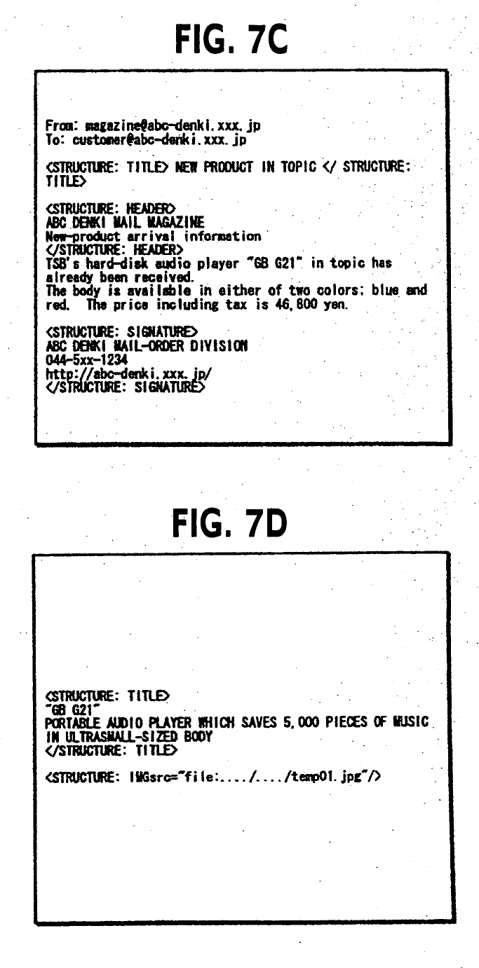

FIGS. 7A-7D show examples of the results of the document structure analysis processes of document analysis means 103.

FIG. 7A illustrates an exemplary result of the document structure process in the case where the information in FIG. 3A has been inputted. Since the input information in FIG. 3A is in HTML, tags which are unrelated to the document structure analysis result, such as “<HTML>”, remain in the output. If the tags need to be removed, they can be easily removed by a known technique.

FIG. 7B shows an exemplary result of the document structure process in the case where the information in FIG. 3B has been inputted. Since the attribute information is “INTERNET” in FIG. 3B, the document structure analysis process is performed using the analytical knowledge in FIG. 5A.

FIG. 7C shows an exemplary result of the document structure process in the case where the information in FIG. 3C has been inputted. Since the attribute information is “MAIL” in FIG. 3C, the document structure analysis process is performed using the analytical knowledge in FIG. 5B.

Since the attribute information is “SCAN” in FIG. 2D, the document structure analysis process is performed by the known technique stated before. FIG. 7D shows an example of the document structure process result in the case where the information in FIG. 2D has been inputted.

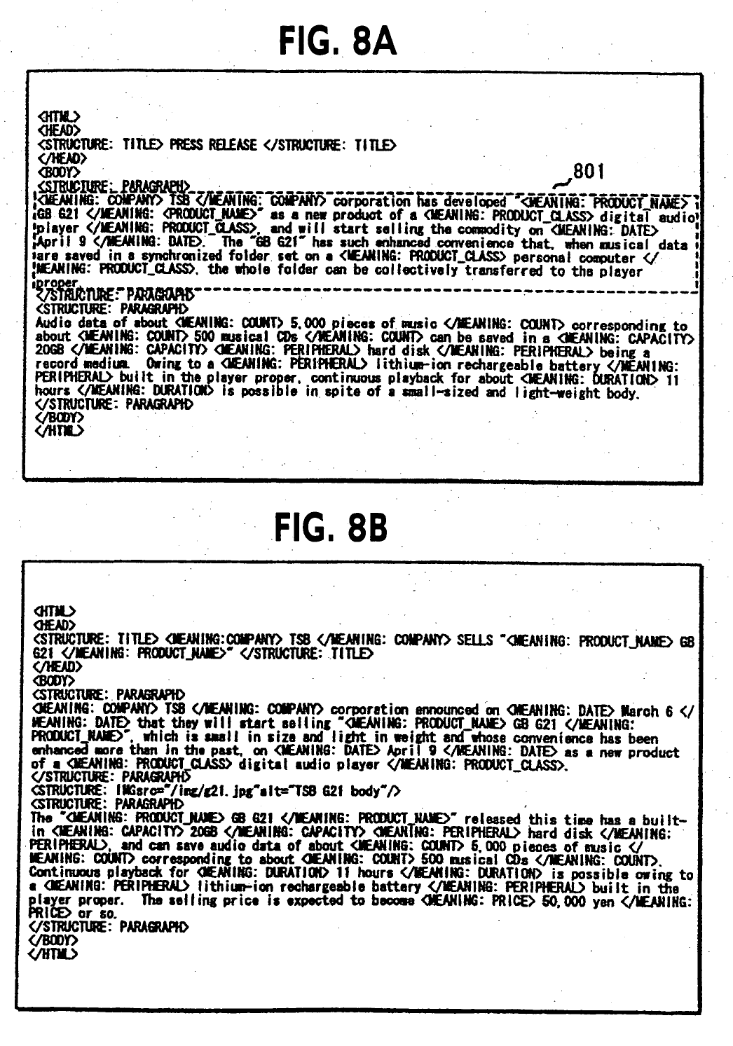

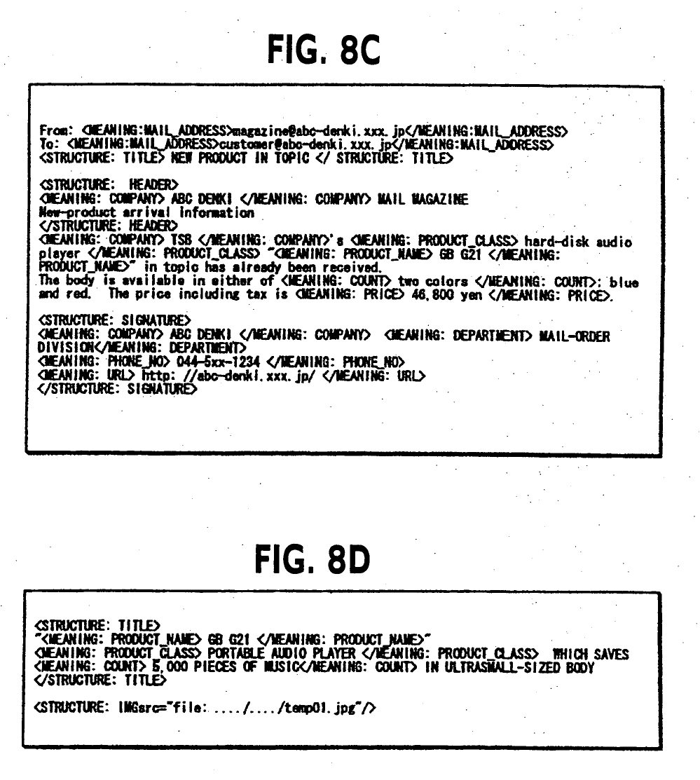

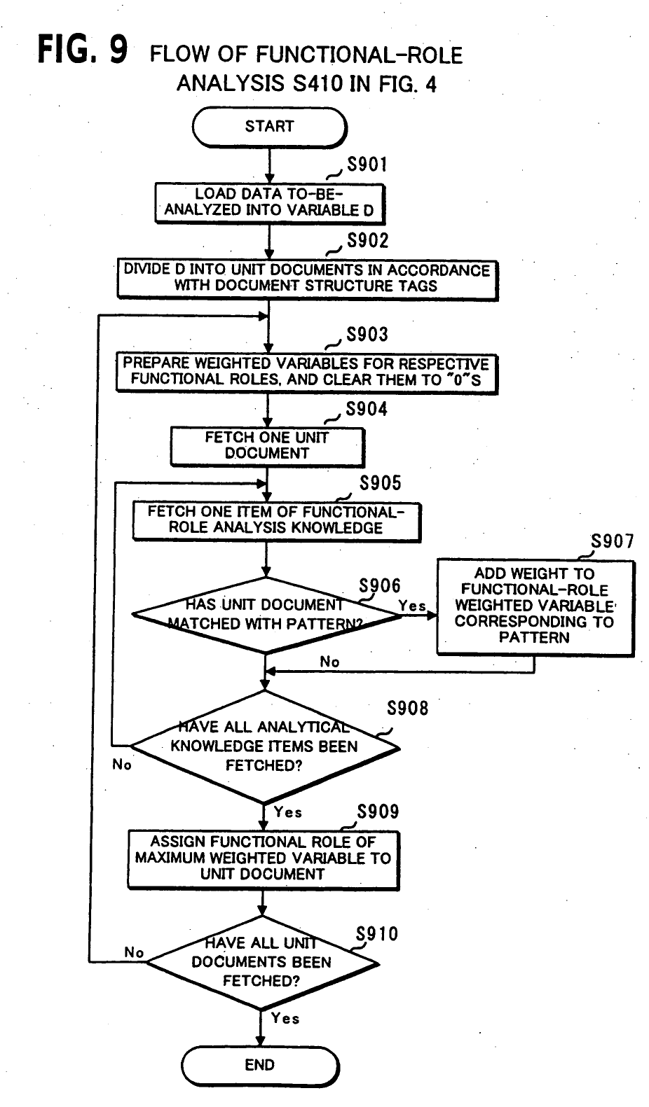

Next, the semantic attribute analysis process of document analysis means 103 (step S409 in FIG. 4) may be conducted using a known technique. The known technique usable is contained in, for example, the research report NL-161-3 (2004) of the 161st Natural Language Processing Research Meeting, the Institute of Information Processing Engineers, the entire contents of this reference being incorporated herein by reference. Results from the semantic attribute analysis process depend upon the contents of the semantic attribute analysis knowledge which is referred to in the semantic attribute analysis process, and which is stored in document-analysis-knowledge storage means 102. In this embodiment, however, it is assumed that processed results shown in FIGS. 8A-8D have been obtained.

Next, the functional role analysis process of document analysis means 103 (step S410 in FIG. 4) will be described with reference to FIG. 9.

A technique contained in, for example, the following document is employed as the functional role analysis process: Masaru SUZUKI et al., “Customer Support Operation with a Knowledge Sharing System KIDS: An Approach based on Information Extraction and Text Structurization”, Proceedings of World Multiconference on Systemics, Cybernetics and Informatics {SC12001, Vol. 7, pp. 89-94 (2001)}, the entire contents of this reference being incorporated herein by reference.

The functional role analysis process differs as to which functional roles of a document are to be analyzed, depending upon the purpose of utilization of each embodiment. In this embodiment, the following functional roles shall be analyzed:

Announcement: Statement of a press release by an enterprise or the like

Account: News item of a newspaper or magazine introduced as fact

Column: Account which states an opinion

Greeting: Letter of greeting based on electronic mail or the like

Explanation: Explanatory note of a term or the like

FIG. 9 is a diagram showing the flow of the functional role analysis process.

Referring to FIG. 9, document analysis means 103 loads the data to-be-analyzed, subjected to the document structure analysis process as well as the semantic attribute analysis process and puts the loaded data into a variable D (step S901).

Subsequently, document analysis means 103 divides the value of variable D on the basis of the result of the document structure analysis process. The individual parts of the divided data to-be-analyzed shall be called “unit documents” here (step S902). Incidentally, the resulting units of the division into unit documents may well differ depending upon the purpose of utilization of each embodiment. In a first embodiment, the result of the document structure analysis process is used for the units. Embodiments consistent with the principles of the present invention, however, is not thusly restricted. By way of example, individual sentences, individual paragraphs, individual documents, or items in a similar hierarchical structure may well be set as the units. Alternatively, as a modified embodiment, in the case where the input is in HTML, not only the result of the document structure analysis process but also the HTML tags themselves may well be used for the delimiters of the unit document division.

In preparation for the analysis, the working variables of the respective functional roles are prepared, and their values are cleared to “0”s (step S903).

Subsequently, document analysis means 103 fetches the divided unit documents one by one (step S904). Further, it fetches functional role analysis knowledge items stored in document-analysis-knowledge storage means 102, one by one (step S905).

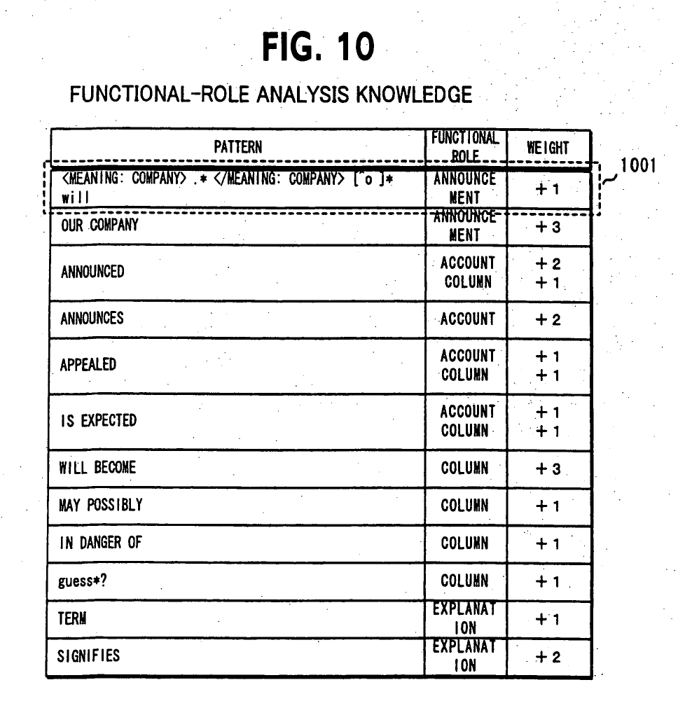

FIG. 10 shows examples of the functional role analysis knowledge. Each item of the functional role analysis knowledge is represented with a set of three parameters; “pattern”, “functional role” and “weight”. As also indicated in FIG. 10, each pattern may well correspond to a plurality of functional roles and weights.

Subsequently, document analysis means 103 examines the matching between the unit document fetched at step S904 and the pattern fetched at step S905 (step S906). In the first embodiment, a describing method and a matching technique for the patterns of the functional role analysis knowledge shall be the same as in the document structure analysis process.

In a case where the unit document has matched with the pattern at step S906 (“Yes” at step S906), document analysis means 103 adds the corresponding weight to the working variable of the corresponding functional role (step S907). In the case where multiple corresponding functional roles are existent, the respective weights are added to all the corresponding functional roles.

Document analysis means 103 iterates the processing of steps S905-S907 for all the items of the functional role analysis knowledge (step S908).

Subsequently, after document analysis means 103 has examined the comparison of one unit document with the patterns of all the functional role analysis knowledge items (“Yes” at the step S908), it compares the individual working variables, and assigns to the unit document the functional role which corresponds to the working variable of the maximum value (step S909). Here, in a case where multiple working variables of the maximum value are existent, multiple functional roles shall be assigned. In a case where the values of all the working variables are “0”s, a role “indefinite” shall be assigned as a special functional role.

Further, when steps S903-S909 have been iterated for all the unit documents (step S910), and the processing for all the unit documents have ended (“Yes” at step S910), the functional role analysis process is ended.

In a case, for example, where the data in FIG. 8A have been inputted to document analysis means 103 in the functional role analysis process, the first unit document divided in accordance with the document structure becomes “<HTML><HEAD>”. Since this unit document is constituted by only the HTML tags, it does not form a subject for the processing in this embodiment.

The next unit document is “PRESS RELEASE”. Since this unit document does not match with any of the patterns of the functional role analysis knowledge shown in FIG. 10, the functional role “indefinite” is assigned thereto.

Further, it is assumed that, with the proceeding of the loop of steps S903-S910, a unit document 801 beginning at the 7th line in FIG. 8A has been fetched at step S904.

The elements of the unit document 801 are successively examined against the patterns of the functional role analysis knowledge as fetched at step S905. Unit document 801 fetched at step S904 by way of example matches with a pattern of knowledge 1001 indicated in FIG. 10 (“Yes” at step S906), so the routine proceeds to step S907, at which the weight “+1” is added to the working variable of the role “announcement,” being the corresponding functional role. Since unit document 801 does not match with any other pattern of the functional role analysis knowledge shown in FIG. 10, the role “announcement” is assigned to the unit document 801 at step S909.

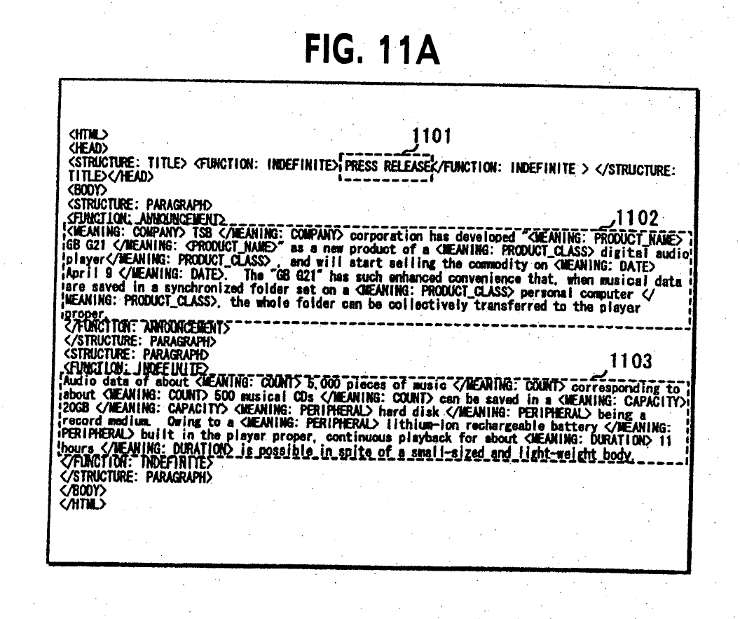

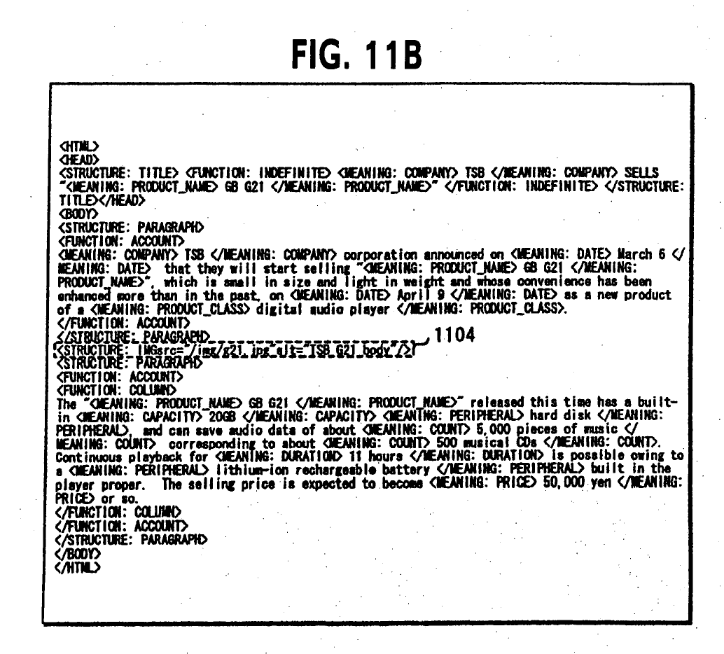

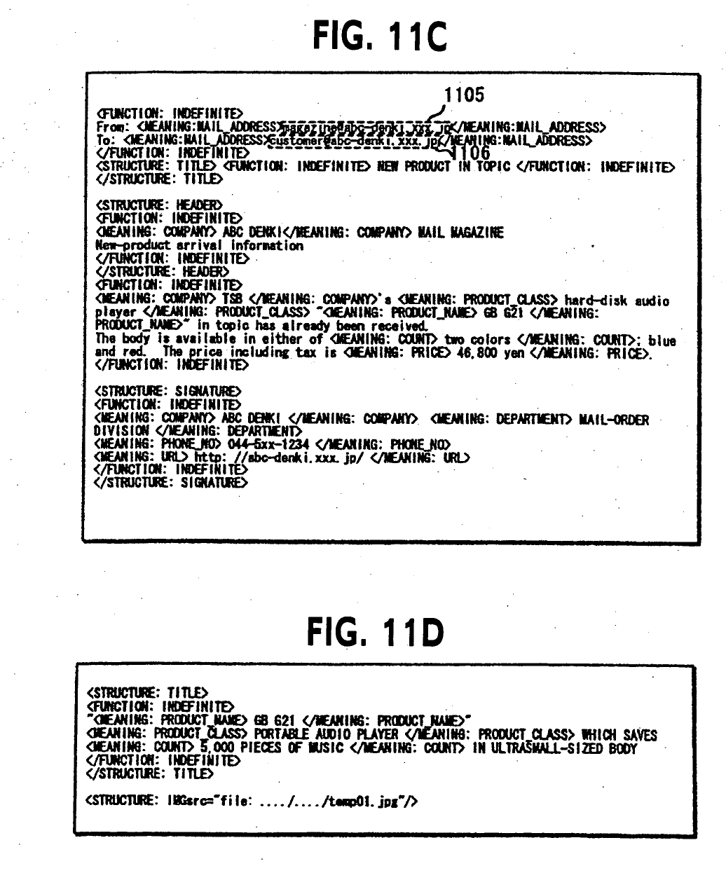

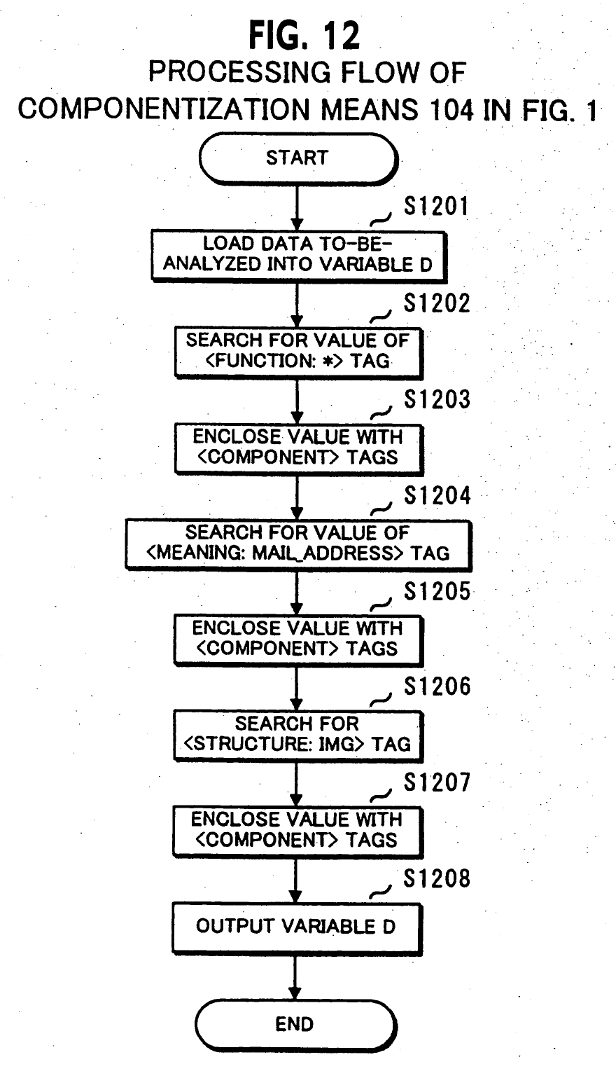

Shown in FIGS. 11A-11D are examples of the processed results of the functional role analysis processes for the respective document data in FIGS. 8A-8D.

The above is the description of the processing contents of the three processes (document structure analysis process, semantic attribute analysis process, and functional role analysis process) of document analysis means 103 in this embodiment.

Next, the flow of processing of componentization means 104 in FIG. 1 will be described with reference to the flow chart of FIG. 12.

Componentization means 104 first loads the data to-be-analyzed, and puts the loaded data into a variable D in preparation for rewriting (step S1201).

Subsequently, componentization means 104 searches for a value enclosed within any “<FUNCTION:*>” tag, within variable D (step S1202), and it encloses the value with “<COMPONENT>” AND “</COMPONENT>” tags (step S1203). Processes such as the search for the tags and the insertion of the tags may be embodied by a known technique such as the existing DOM (Document Object Model) or “XPath”. In a case where multiple <FUNCTION:*> tags have been searched for at step S1202, the processes of step S1203 are executed for the respective tags. However, in a case where the <FUNCTION:*> tags are successive in nested fashion, only the value of the innermost one of the successive <FUNCTION:*> tags is set as a subject for the process.

Subsequently to step S1203, componentization means 104 searches for a value enclosed with a “<MEANING:MAIL_ADDRESS>” tag, within the variable D (step S1204), and it encloses the value with “<COMPONENT>” and “</COMPONENT>” tags (step S1205). In a case where multiple “<MEANING:MAIL_ADDRESS>” tags have been searched for at step S1204, the processes of step S1205 are executed for the respective tags.

Subsequently to step S1205, componentization means 104 searches for any “<STRUCTURE:IMG*>” tag (step S1206), and it encloses the “<STRUCTURE:IMG*>” tag with “<COMPONENT>” and “</COMPONENT>” tags (step S1207). In a case where multiple “<STRUCTURE:IMG*>” tags have been searched for at step S1206, the processes of step S1207 are executed for the respective tags.

Subsequently to step S1207, componentization means 104 outputs variable D which has been rewritten at steps S1202-S1207, as an analyzed result (step S1208). Then, the componentization process is ended.

Next, the componentization process will be described by example.

In a case, for example, where the document data in FIG. 11A has been inputted, parts indicated by reference numerals 1101, 1102 and 1103 in FIG. 11A are searched for at step S1202, and they are respectively enclosed within the <COMPONENT> tags. Furthermore, parts indicated by reference numerals 1105 and 1106 in FIG. 11C are searched for at step S1204, and a part indicated by reference numeral 1104 in FIG. 11B is searched for at step S1206.

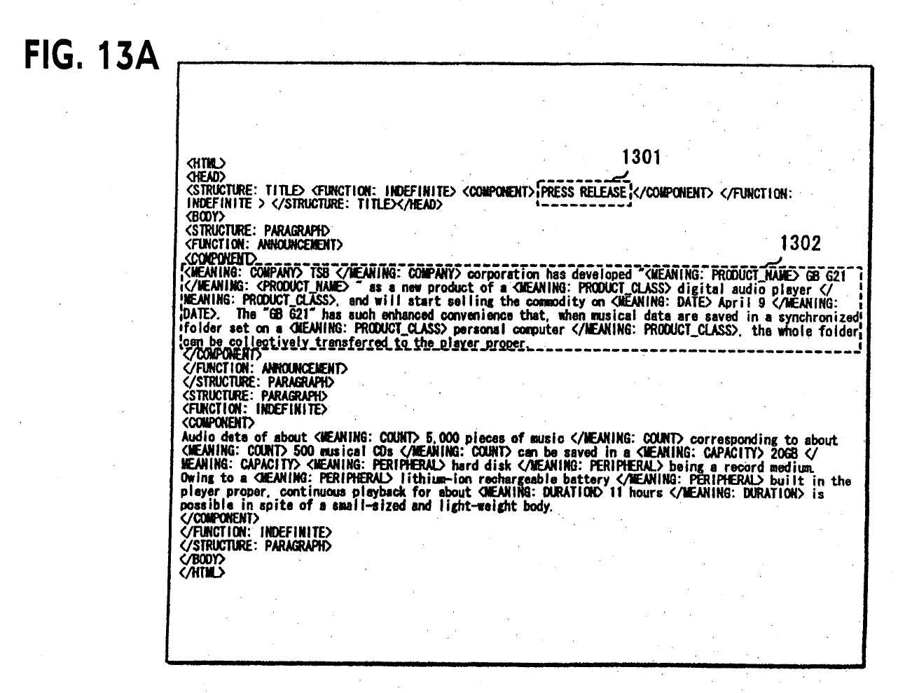

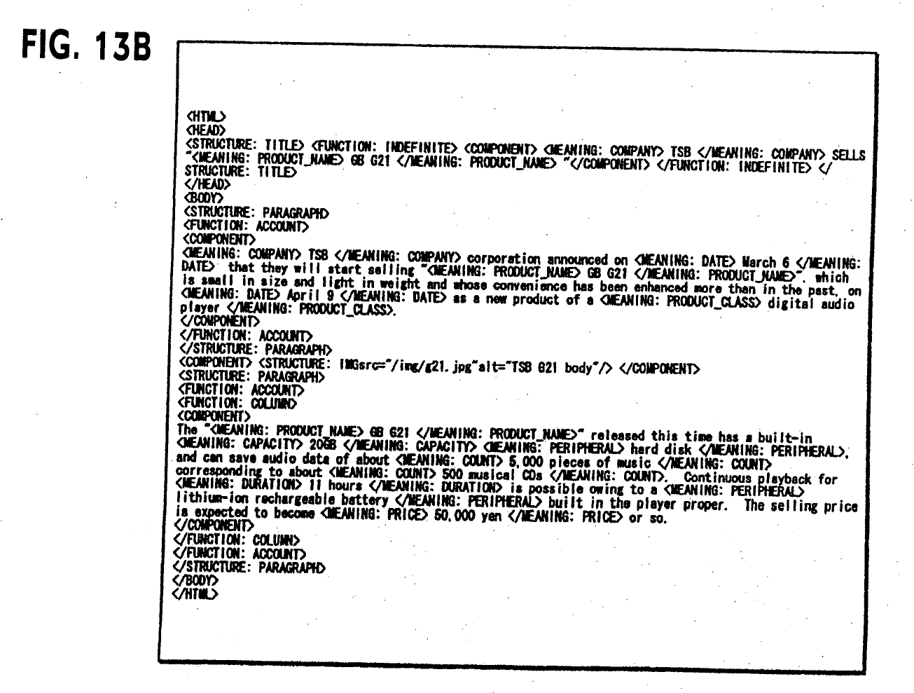

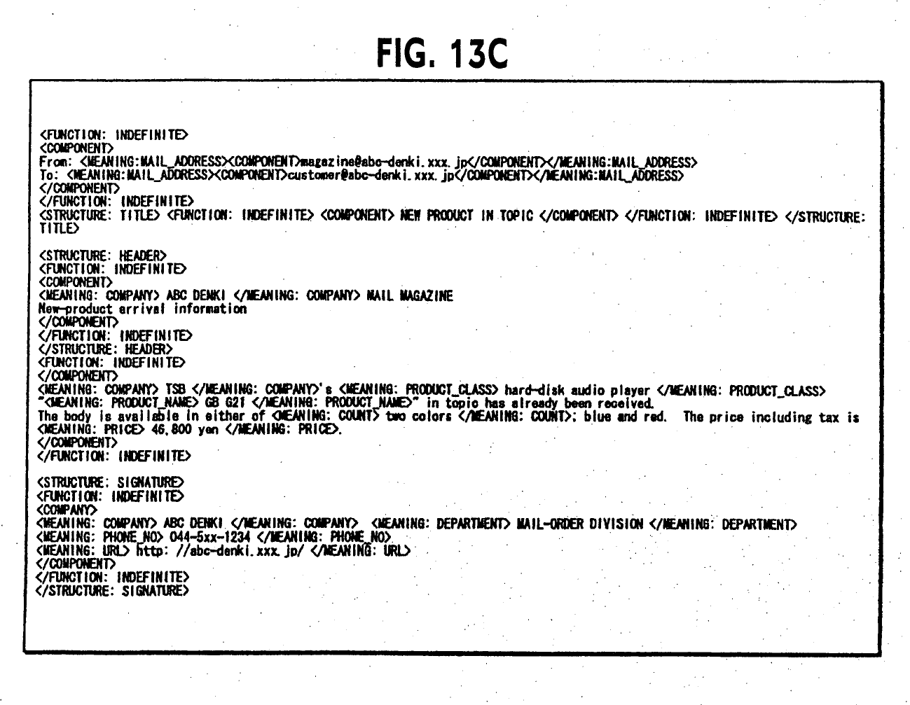

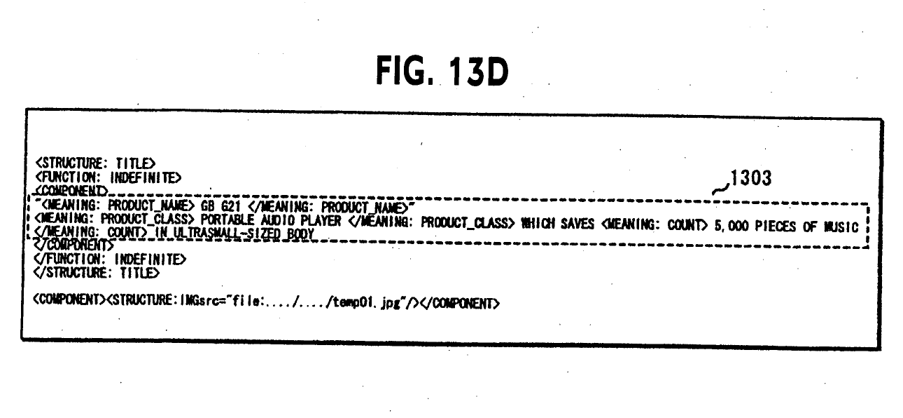

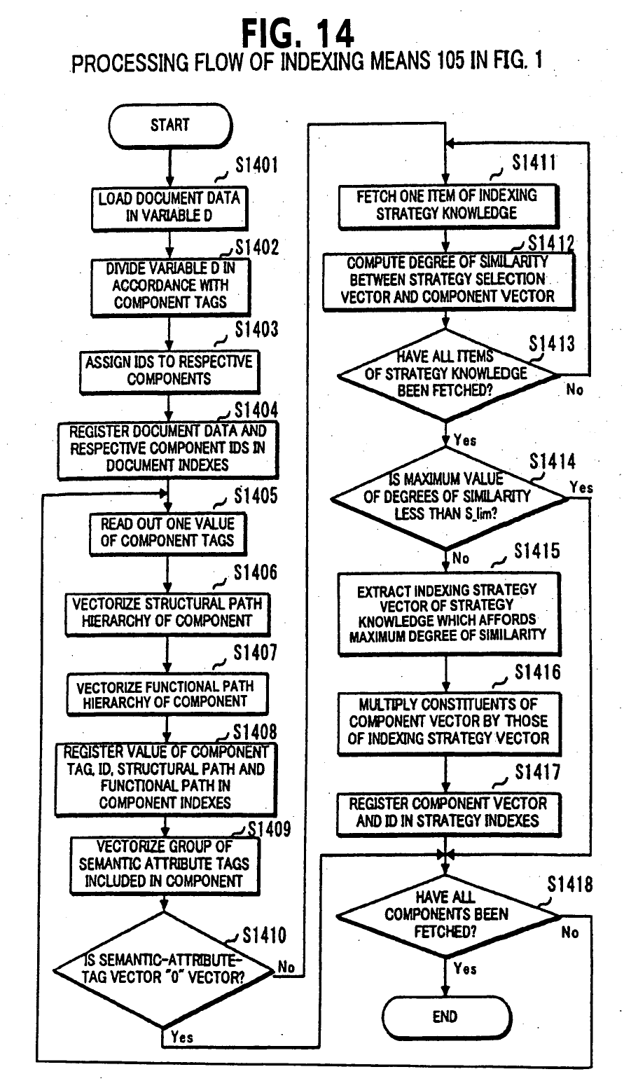

FIGS. 13A-13D are diagrams showing examples of the processed results of componentization means 104 in the cases where the respective document data in FIGS. 11A-11D has been inputted.

Next, the process flow of indexing means 105 in FIG. 1 will be described with reference to the flow chart in FIG. 14.

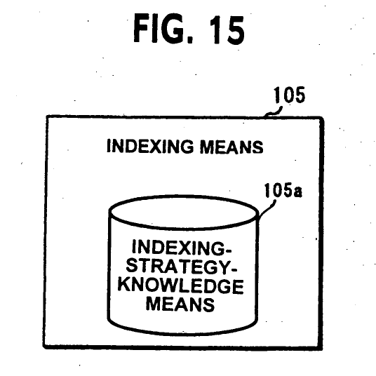

Indexing means 105 includes indexing-strategy-knowledge storage means 105a as shown in detail in FIG. 15.

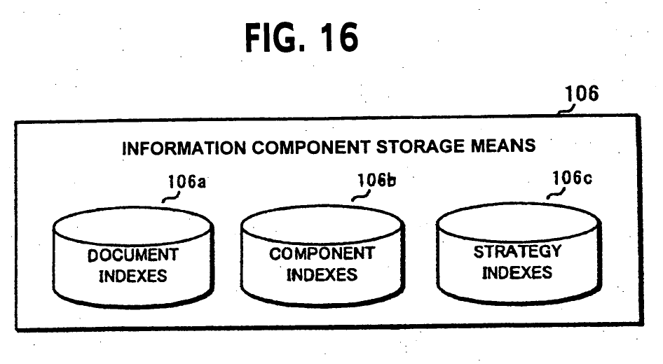

Information component storage means 106 is contains document indexes 106a, component indexes 106b and strategy indexes 106c as shown in detail in FIG. 16.

Indexing means 105 first loads the document data to-be-indexed, and puts the loaded data into a variable D (step S1401).

Next, indexing means 105 divides variable D into component data delimited by component tags (“<COMPONENT>” and “</COMPONENT>” tags) in the case of the componentization of the document data by componentization means 104 (step S1402).

Following step S1402, indexing means 105 assigns identifiers (component identifiers ID) to the respective components so that the identifiers may be referenced later (step S1403). A method for generating the IDs can be embodied by a known technique. The IDs may be, for example, numerical values of sufficient digits based on random numbers, or alphabetic strings.

Next, indexing means 105 indexes the document data in which the component IDs were assigned to the respective components at step S1403, and it stores the document data and the IDs in document indexes 106a (step S1404). The indexing technique may have been incarnated in known document database technology.

Next, indexing means 105 reads out the component data items obtained at step S1402, one by one (step S1405).

Then, indexing means 105 finds the path (hierarchy) of document structure tags until arrival at the component tags of the component data extracted at step S1405, within the original data inputted to indexing means 105. It converts the path into a vector. v_1 (step S1406). Here, in a case where any document structure tag is included within the component tags, it shall also be included in the vector v_1.

Subsequently, indexing means 105 finds the path (hierarchy) of functional role tags till the arrival at the component data extracted at step S1405, within the original data inputted to indexing means 105. It converts the path into a vector v_2 (step S1407).

Following step S1407, indexing means 105 registers the four values of component data, component ID, vector v_1 and vector v_2 in component indexes 106b (step S1408).

Next, indexing means 105 fetches all the labels of a group of semantic attribute tags which are included in the component data value extracted at step S1405, and it converts the labels into a vector v_3 (step S1409).

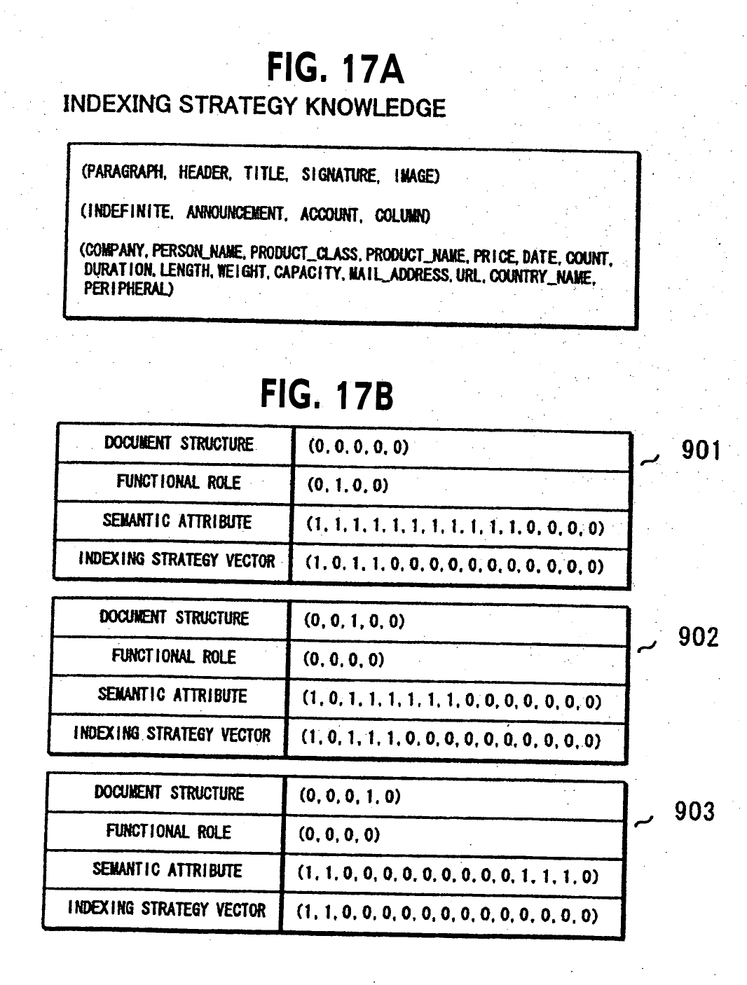

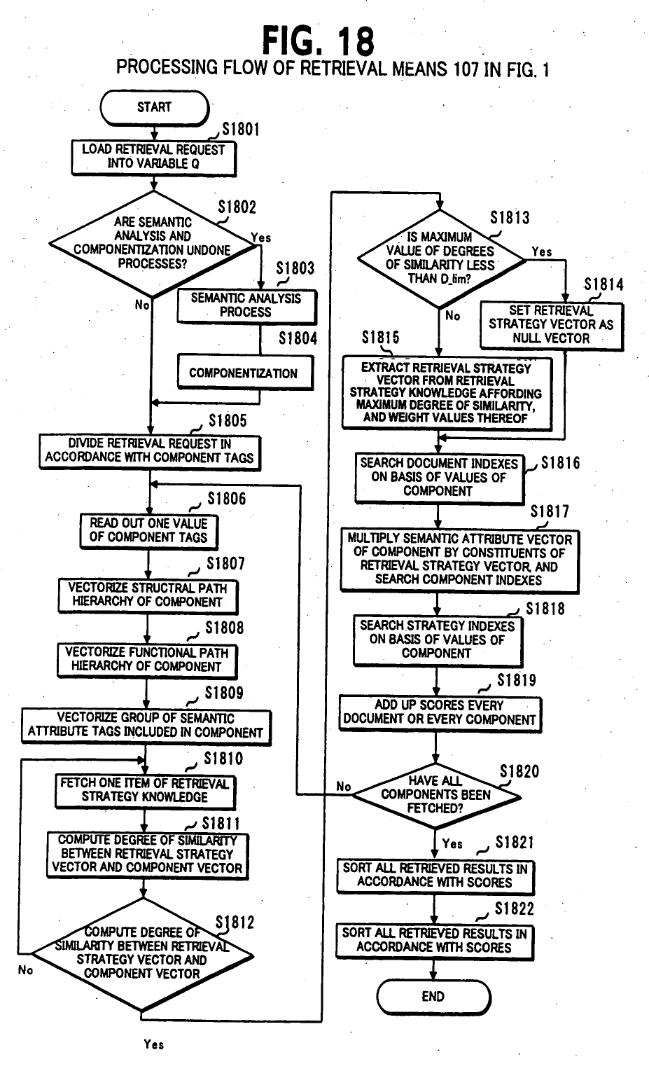

Subsequent to step S1409, when vector v_3 is a null vector (whose constituents are all “0”s) at step S1409 (“Yes” at step S1410), indexing means 105 proceeds to step S1418 (to be explained later), without executing registration in strategy indexes 106c. When vector v_3 is not a null vector, indexing means 105 proceeds to step S1411 (step S1410). The conversions (base) into the respective vectors v_1, v_2 and v_3 will be described with reference to FIG. 17A later.

Then, indexing means 105 fetches one indexing strategy knowledge item stored in indexing-strategy-knowledge storage means 105a (step S1411).

Here, examples of the indexing strategy knowledge are shown in FIGS. 17A and 17B. The indexing strategy knowledge is constituted by an indexing strategy selection vector consisting of the three vectors of a document structure vector, a functional role vector and a semantic attribute vector, and an indexing strategy vector.

FIG. 17A represents the base constituents of the document structure vector, functional role vector and semantic attribute vector from above, respectively.

By way of example, a state where only “COMPANY” occurs in the semantic attribute vector is represented as (1, 0, 0, 0, 0, 0, 0, 0, 0, 0, 0, 0, 0, 0, 0). The indexing strategy vector takes the same base as that of the semantic attribute vector of the indexing strategy selection vector.

Numerals 901, 902 and 903 in FIG. 17B designate examples of the indexing strategy knowledge, respectively. Respective vectors indicated as “document structure”, “functional role” and “semantic attribute” are the constituent vectors of the indexing strategy selection vector. A vector which is indicated as “strategy vector” in FIG. 17B is the indexing strategy vector. In the first embodiment, it is assumed that each constituent of the indexing strategy knowledge vector has a value of either “0” or “1”.

The description on the processing of indexing means 105 will be continued by referring back to FIG. 14.

Indexing means 105 computes the inner products (d_1, d_2 and d_3) between each indexing strategy selection vector of the indexing strategy knowledge fetched at step S1411 and the vectors v_1, v_2 and v_3, and it totals the computed values to compute the degree of similarity S between the component data and the indexing strategy selection vector (step S1412).

Indexing means 105 executes the processing of steps S1411 and S1412 iteratively for all the items of the indexing strategy knowledge (step S1413).

Subsequent to step S1413, when the degrees of similarity S are less than a predetermined threshold value S_lim for all the items of the indexing strategy knowledge, indexing means 105 proceeds to step S1418 (to be explained later), without executing the registration in the strategy indexes 106c. When the degrees of similarity S are not less than a predetermined threshold value S_lim for all the items of the indexing strategy knowledge, indexing means 105 proceeds to step S1415 (step S1414).

In step S1415, indexing means 105 extracts from indexing-strategy-knowledge storage means 105a, an indexing strategy knowledge vector v_s which corresponds to the indexing strategy selection vector being greater than the threshold value S_lim and affording the maximum degree of similarity S (step S1415).

Subsequent to step S1415, indexing means 105 sets as a new vector v_3, the product between the constituents of the semantic attribute vector (vector v_3) of the component data and the indexing strategy knowledge vector (vector v_s) (step S1416).

Next, indexing means 105 registers the constituents of the new vector v_3 in strategy indexes 106c as the weight of a word endowed with the corresponding semantic attribute, together with the component ID (step S1417).

Indexing means 105 iterates the processing of steps S1405-S1417 for all the components which are included in all the document data (variable D) (step S1418).

In a case, for example, where the data in FIG. 13A has been inputted to indexing means 105 as the document data, the component vectors of a first component 1301 in FIG. 13A become:
v_{—}1=(0, 0, 1, 0, 0)
v_{—}2=(1, 0, 0, 0)

v_3=(0, 0, 0, 0, 0, 0, 0, 0, 0, 0, 0, 0, 0, 0, 0) in accordance with steps S1406, S1407 and S1409 in FIG. 14. Since the semantic attribute vector v_3 has no semantic attribute tag, it is a null vector. Accordingly, the judgment at step S1410 in FIG. 14 becomes “Yes”, and vector v_3 is not registered in the strategy indexes 106c.

The component vectors of a next component 1302 in FIG. 13A become:
v_{—}1=(1, 0, 0, 0, 0)
v_{—}2=(0, 1, 0, 0)
v_{—}3=(1, 0, 1, 1, 0, 1, 0, 0, 0, 0, 0, 0, 0, 0, 0)

Even in a case where multiple identical elements exist in the vector, the respective constituents of the vector shall take the values of either “0” or “1” in the first embodiment.

Regarding component 1302 in FIG. 13A, the degrees of similarity to the indexing strategy selection vectors at the reference numerals 901, 902 and 903 in FIG. 17B are respectively computed as given below.

Reference numeral 901:
d_{—}1=0
d_{—}2=1
d_{—}3=4
similarity S=5

Reference numeral 902:
d_{—}1=0
d_{—}2=0
d_{—}3=4
similarity S=4

Reference numeral 903:
d_{—}1=0
d_{—}2=0
d_{—}3=1
similarity S=1

As a result, the degree of similarity S becomes the greatest in the case of reference numeral 901. Accordingly, indexing means 105 registers a new vector (1, 0, 1, 1, 0, 0, 0, 0, 0, 0, 0, 0, 0, 0, 0) obtained by multiplying the vector v_3 by the individual constituents of the indexing strategy vector at reference numeral 901, in strategy indexes 106c as the weights of words endowed with the semantic attributes corresponding to the respective constituents.

More specifically, here in this case, the four items of “TSB” endowed with the <meaning:COMPANY> tag, “digital audio player” and “personal computer” endowed with the <meaning:PRODUCT_CLASS> tags, and “GB G21” endowed with the <meaning: PRODUCT_NAME> tag have the weights of “1”, respectively, and “April 9” endowed with the <meaning:DATE> tag has the weight of “0” and is thus excluded from the strategy indexes 106c.

In this way, the document data inputted to indexing means 105 is stored in information component storage means 106.

Next, the flow of the processing of retrieval means 107 in FIG. 1 will be described with reference to the flow chart of FIG. 18.

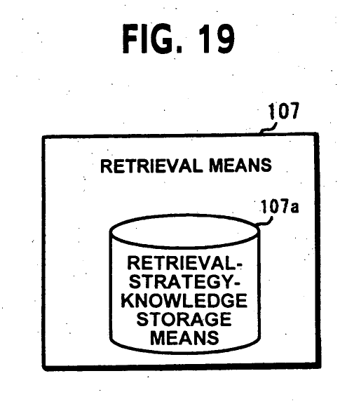

As shown in detail in FIG. 19, retrieval means 107 includes retrieval-strategy-knowledge storage means 107a.

Referring to FIG. 18, retrieval means 107 accepts the input of a retrieval request (step S1801).

Subsequently, retrieval means 107 judges whether or not a semantic analysis process and an componentization process are incomplete processes, as to the retrieval request accepted at step S1801 (step S1802).

In a case where the semantic analysis process and the componentization process are incomplete processes as the result of the judgment at step S1802 (“Yes” at step S1802), retrieval means 107 executes the semantic analysis process through document analysis means 103 (step S1803), and the componentization process through componentization means 104 (step S1804).

Next, retrieval means 107 divides the retrieval request subjected to the semantic analysis process and the componentization process beforehand or at steps S1803 and S1804, in accordance with component tags (step S1805).

Subsequently, retrieval means 107 reads out components divided at step S1805, one by one (step S1806), vectorizes the path of a structural tag in the document data (step S1807), vectorizes the path of a functional tag in the document data (step S1808), and vectorizes the labels of a group of semantic attribute tags included in the component (step S1809).

The details of the vectorization processes at steps S1807-S1809 are the same as at steps S1406, S1407 and S1409 in FIG. 14, respectively.

Here, a vector obtained at step S1807 is designated by v_1, a vector obtained at step S1808 is designated by v_2, and vector obtained at step S1809 is designated by v_3.

One item of retrieval strategy knowledge is fetched from retrieval-strategy-knowledge storage means 107a included in retrieval means 107 (step S1810). The inner products (d_1, d_2 and d_3) between a document structure vector, a functional role vector and a semantic attribute vector included in the retrieval strategy knowledge item and the respectively corresponding vectors included in the component are computed, and the computed values are totaled to compute the degree of similarity D_i between the retrieval strategy vector and the component vector (step S1811). The method for computing the degree of similarity D_i is the same as at step S1412 in FIG. 14.

Subsequently, retrieval means 107 finds the degrees of similarity D_i for all items of retrieval strategy knowledge (step S1812), and it judges whether or not the maximum value of the degrees of similarity D_i is less than a predetermined threshold value D_lim (step S1813).

When the maximum value of the degrees of similarity D_i is less than the value D_lim (“Yes” at step S1813), the retrieval strategy vector is set as a null vector whose constituents are all “0”s (step S1814).

When the maximum value of the degrees of similarity D_i is not less than the value D_lim (“No” at step S1813), the retrieval strategy vector is extracted from the retrieval strategy knowledge which affords the maximum degree of similarity D_i (step S1815).

Subsequently, retrieval means 107 executes a retrieval process. Here, it outputs a retrieved result which is unified from the retrieved results of three loops as stated below.

Retrieval means 107 searches document indexes on the basis of the values of the component tags, and stores the retrieval scores of retrieved documents (step. S1816).

Next, as to the retrieval strategy knowledge vector extracted at step S1815, retrieval means 107 multiplies the weights of words included in individual meaning tags corresponding to the respective constituents of the retrieval strategy knowledge vector, by these constituents as coefficients, and it searches the component indexes. Further, retrieval means 107 stores the retrieval scores of the individual retrieved components (step S1817).

Subsequently, retrieval means 107 searches strategy indexes on the basis of the values of the component tags, and the retrieval scores of individual retrieved components are stored (step S1818). Incidentally, each retrieval (score ring) process is a known technique and shall be omitted from detailed description here.

Then, retrieval means 107 adds up the scores stored at steps S1816-S1818, for every document or every component, so as to further store the resulting score (step S1819).

Following step S1819, retrieval means 107 executes the processing of steps S1806-S1819 for all the components of the componentized retrieval request (step S1820).

Subsequently, when retrieval means 107 has executed the retrieval process for the whole retrieval request, it sorts the retrieved documents or components in accordance with the scores added up and stored at step S1819 (step S1821), and it outputs the sorted results (step S1822). Here, the documents and the components shall be separately sorted and outputted.

Now, a component 1303 shown in FIG. 13D is set as a practicable example of the retrieval request as an example of the document to-be-registered anew. Then, the vectors v_1, v_2 and v_3 are as follows:
v_{—}1=(0, 0, 1, 0, 0)
v_{—}2=(1, 0, 0, 0)
v_{—}3=(0, 0, 1, 1, 0, 0, 1, 0, 0, 0, 0, 0, 0, 0, 0)

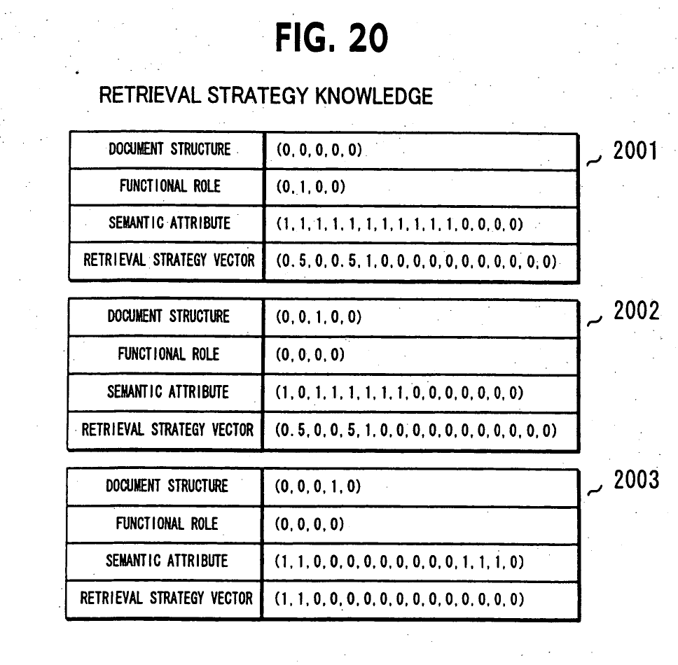

The degrees of similarity of these vectors to individual examples of the retrieval strategy knowledge as shown in FIG. 20 are computed as follows:

Strategy vector at reference numeral 2001:
d_{—}1=0
d_{—}2=0
d_{—}3=3
D_i=3

Strategy vector at reference numeral 2002:
d_{—}1=1
d_{—}2=0
d_{—}3=3
D_i=4

Strategy vector at reference numeral 2003:
d_i=0
d_{—}2=0
d_{—}3=0
D_i=0

Accordingly, the retrieval strategy knowledge as to which the degree of similarity D_i becomes the maximum is the strategy vector at reference numeral 2002.

If the maximum value D_lim is less than 4, the strategy vector at reference numeral 2002; (0.5, 0, 0.5, 1, 0, 0, 0, 0, 0, 0, 0, 0, 0, 0, 0) is utilized at step S1816. More specifically, the component indexes are searched by setting “1” as the weight of the word “GB G21” endowed with PRODUCT_NAME as the meaning tag in the retrieval request, “0.5” as the weight of the word “portable audio player” endowed with PRODUCT_CLASS, and “0” as the weight of any other word.

Although the constituent of COMPANY is 0.5 in the strategy vector, no corresponding meaning tag exists in the retrieval request, and hence, this word COMPANY is neglected here.

Regarding “5,000 pieces of music” endowed with the meaning tag of COUNT in the retrieval request, the corresponding component of the strategy vector is “0”, so that this word is neglected at step S1816.

At step SI817, only the words registered in the strategy indexes by indexing means 105 become subjects for the retrieval. In the case of component 1302 in FIG. 13A by way of example, therefore, importance is attached to the words “TSB”, “digital audio player”, “personal computer” and “GB G21” as stated before.

As described above, consistent with the principles of the present invention, the weights of individual words in the indexes are appropriately altered depending upon the document structures, functional roles and included semantic attributes of the individual parts of document data, whereby the document information processing apparatus capable of executing appropriate indexing dependent upon the context of the document data can be provided. It is permitted to perform a high degree of control, for example, to facilitate retrieving important words in every context, or to previously remove words which might become garbage.

Moreover, retrieval is performed depending also upon the context of a retrieval request, whereby the document information processing apparatus capable of exactly obtaining necessary information can be provided. By way of example, when the part (component) of the document data has been given as the retrieval request, the weights of individual words serving as retrieval keywords are appropriately altered depending upon the document structures and functional roles of the document data which include the component being the retrieval request, and semantic attributes which are included in the retrieval request, whereby a high degree of retrieval control dependent upon the context of the retrieval request becomes possible.

Typically, this embodiment is embodied by a computer which is controlled by software. The software in this case includes programs and data; the operations and advantages of this invention are realized by physically exploiting the hardware of the computer, and appropriate prior-art techniques are applied to the parts to which the prior-art techniques are applicable. Further, the concrete sorts and architectures of the hardware and software for incarnating this invention, a range to be processed by the software, etc., are optionally alterable. In the ensuing description, accordingly, references will be made to virtual functional block diagrams in which respective functions constituting this invention are illustrated as blocks. Incidentally, a program for incarnating this invention by operating the computer is also one aspect of this invention.

### Second Embodiment

Now, the second embodiment of this invention will be described with reference to the drawings. In the second embodiment, a user can easily perform editing by employing a template. The same constructions, operations, etc., as in the first embodiment will be designated by the same reference numerals and signs, and they shall be omitted from description.

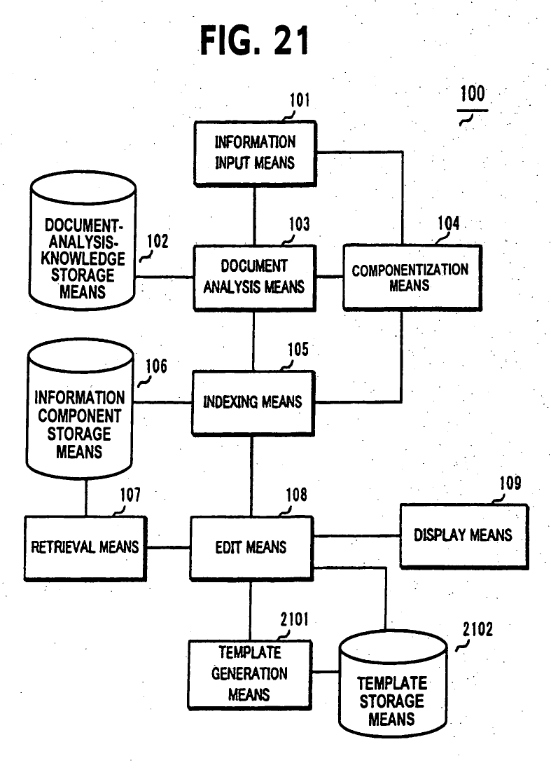

FIG. 21 is a diagram showing the construction of a document information processing apparatus according to the second embodiment of this invention.

As shown in FIG. 21, document information processing apparatus 100 is additionally provided with a template generation means 2101 and a template storage means 2102 as compared with that in FIG. 1.

Edit means 108 edits new contents by utilizing at least one of the information components retrieved by retrieval means 107. Edit means 108 sends the edited contents to indexing means 105. Then, indexing means 105 affords an index as a new information component and stores the information component in information component storage means 106.

Here, edit means 108 edits the new contents by utilizing the information component retrieved by retrieval means 107. Edit means 108, however, may well perform editing by utilizing an information component obtained by any other means different from retrieval means 107, in such a way that the information component outputted to a file, for example, is invoked by a filename. Also, edit means 108 can process editing in accordance with a template. Template storage means 2102 stores therein templates with which edit means 108 performs the editing.

The templates to be stored in template storage means 2102 may well be generated by any other means which is not included in the document information processing apparatus of this invention, or they may well be generated by reflecting the contents of an edit process which the user performed using edit means 108.

Template generation means 2101 generates the template for the edit process, on the basis of a document analysis result based on document analysis means 103 and the contents of the edit process of edit means 108, and it stores the generated template in template storage means 2102.

First, edit means 108 will be described.

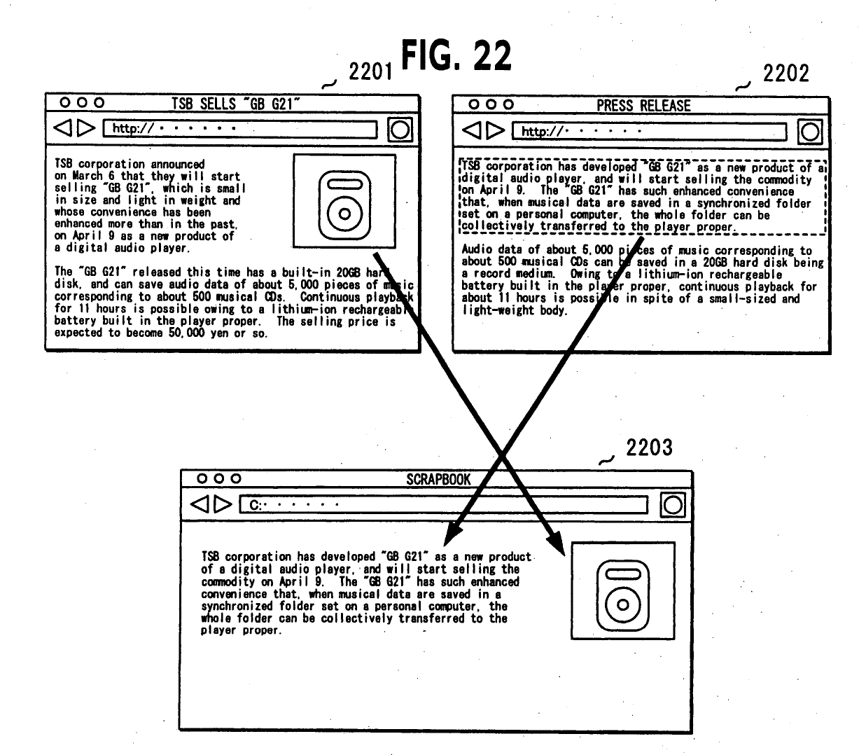

FIG. 22 shows examples of the screens of an editing job which employs the edit means 108.

Numeral 2203 designates a scrapbook which serves as the work space of the editing job. Numeral 2201 designates components included in FIG. 2B. Numeral 2202 designates components included in FIG. 2A.

Components 2201 and 2202 are arranged on scrapbook 2203.

Such an editing job is incarnated by the prior-art software product mentioned in the section of the prior art.

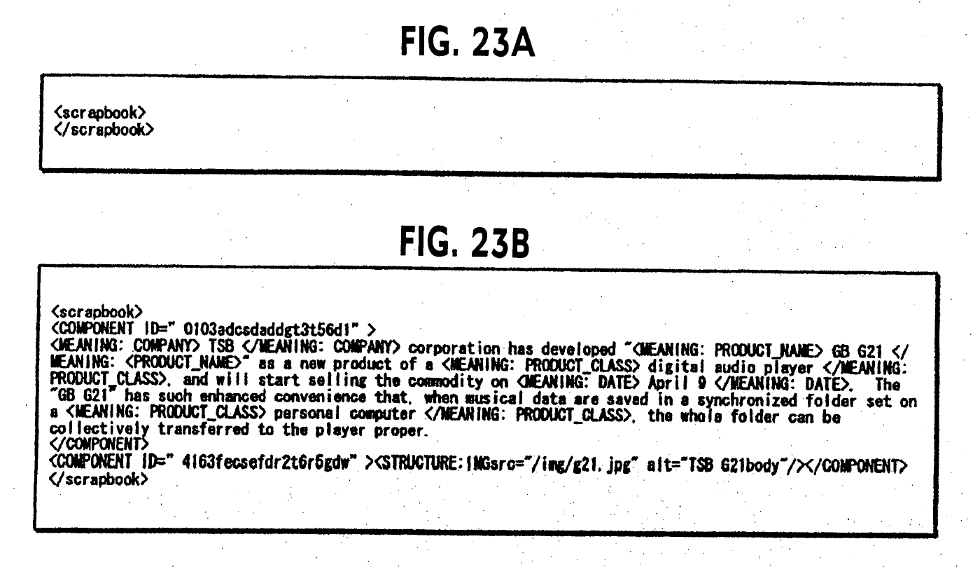

Examples of the data representations of the scrapbook are shown in FIGS. 23A and 23B.

FIG. 23A shows the data of the scrapbook in the state where no component is included. FIG. 23B shows the data of the scrapbook in the state of scrapbook 2203. Individual components included in FIG. 23B bear particular IDs afforded at step S1403 of the flow chart in FIG. 14. Therefore, even after the editing job has been performed by edit means 108, the individual components can be identified.

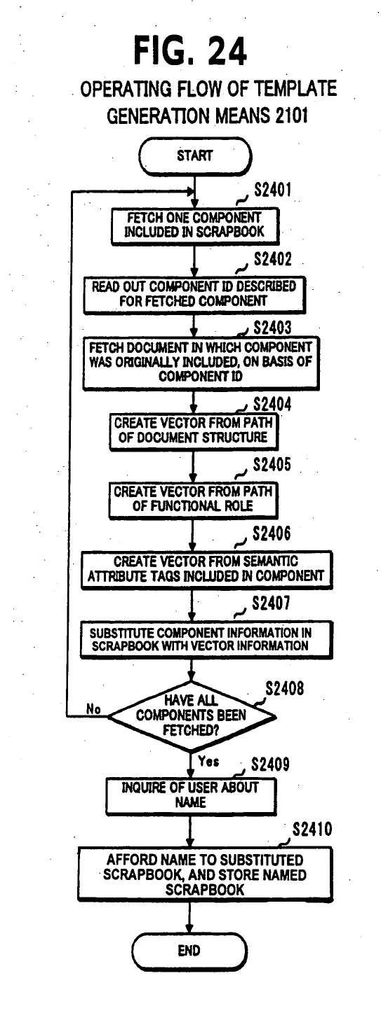

Next, the operation of template generation means 2101 will be described with reference to the flow chart of FIG. 24.

First, template generation means 2101 fetches one component included in the scrapbook (step S2401) and extracts the component ID described for the fetched component, from information component storage means 106 (step S2402).

Subsequently, template generation means 2101 fetches the document data in which the component was originally included, with a clue being the component ID extracted at step S2402 (step S2403).

Template generation means 2101 finds the path (hierarchy) of document structure tags until arrival at the component tags of the component data in the document data, and converts the path into a vector v_1 (step S2404). Here, in a case where any document structure tag is included within the component tags, it shall also be included in the vector v_1. Likewise, template generation means 2101 finds the path (hierarchy) of functional role tags until the arrival at the component data of the document data, and it converts the path into a vector v_2 (step S2405).

Further, template generation means 2101 fetches all the labels of the semantic attribute tags which are included in the value of the component data value, and it converts the labels into a vector v_3 (step S2406).

Processing steps S2404, S2405 and S2406 are similar to steps S1406, S1407 and S1409 in the flow of FIG. 14, respectively.

Following step S2406, template generation meahs 2101 converts the three generated vectors v_1, v_2 and v_3 into respective character strings, and it substitutes the component information of the scrapbook with the character strings (step S2407).

The processing of steps S2401-S2407 is iterated for all components in the scrapbook (step S2408).

When the processing has been completed for all the components in the scrapbook (“Yes” at step S2408), template generation means 2101 requests the user to input the name of the generated template by a hitherto-known GUI technique (step S2409). Further, template generation means 2101 stores the scrapbook in which the component parts have been substituted, in template storage means 2102 as the template to which the template name inputted at step S2409 has been afforded (step S2410).

In this way, template generation means 2101 generates the template and stores the generated template in template storage means 2102.

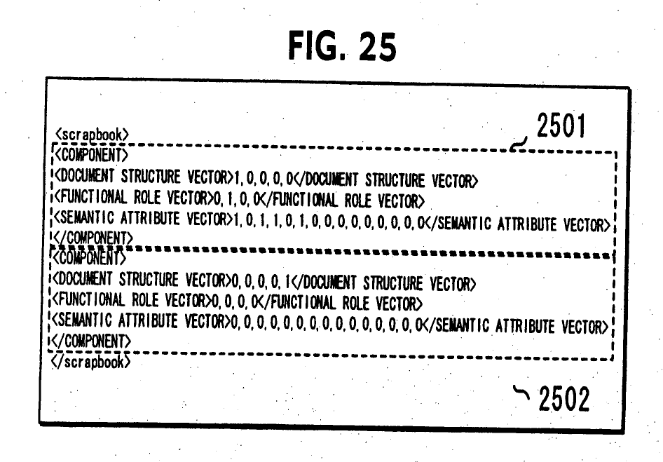

An example of a template thus converted from FIG. 23B by template generation means 2101 is shown in FIG. 25.

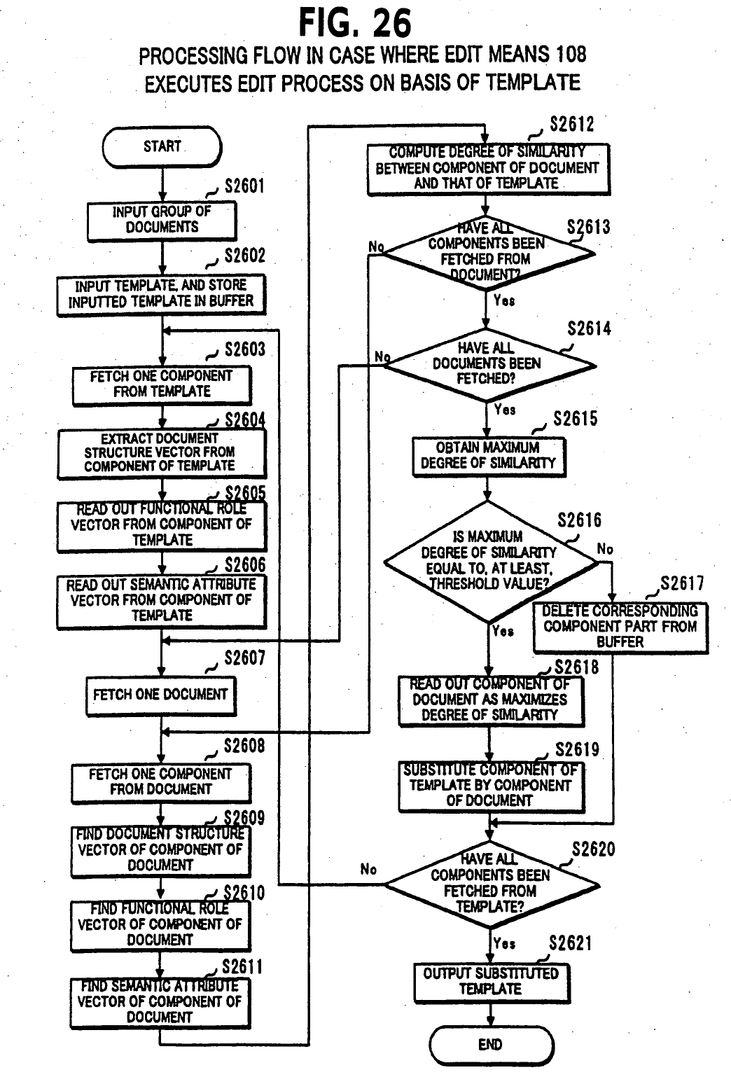

Now, the flow of processing in the case where edit means 108 executes an edit process on the basis of a template will be described with reference to FIG. 26.

In this case, the user inputs to edit means 108 multiple documents which are to be subjected to the edit process. In a case where the group of documents has not undergone semantic analysis and componentization, the semantic analyses and componentizations shall be respectively performed by document analysis means 103 and componentization means 104 already explained.

First, edit means 108 accepts the inputting of the group of documents (step S2601). Here, a case where all the documents are inputted at one time will be considered, but the documents may well be given one by one so as to successively process them.

Next, edit means 108 loads the template previously selected by the user with a clue being the name afforded to this template, and it copies the template into a buffer in order to rewrite this template later (step S2602).

Subsequently, edit means 108 fetches one component from the template (step S2603).

Then, edit means 108 extracts the document structure vector (v_1), the functional role vector (v_2) and the semantic attribute vector (v_3) obtained by template generation means 2101 and described for each component of the template as explained in conjunction with FIG. 24 before, from the template fetched at step S2603 (steps S2604-S2606).

Following step S2604, edit means 108 fetches one document from among the group of documents inputted at step S2601 (step S2607), and it extracts one component from the fetched document (step S2608).

Subsequently, edit means 108 finds a document structure vector (v_1′), a functional role vector (v_2′) and a semantic attribute vector (v_3′) as to the component extracted at step S2608 and in the same procedures as at steps S2404, S2405 and S2406 in FIG. 24, respectively (steps S2609-S2611).

Next, edit means 108 computes the inner product (s_1) between the vectors v_1 and v_1′, the inner product (s_2) between the vectors v_2 and v_2′ and the inner product (s_3) between the vectors v_3 and v_3′, as to the vectors extracted at steps S2604-S2606 and the vectors extracted at steps S2609-S2611, thereby to compute the degree of similarity S_i (=s_1+s_2+s_3) between the components. It temporarily stores the computed degree of similarity (step S2612).

Subsequently, edit means 108 iterates the processing of steps S2608-S2612 for all the components which are included in the document fetched at step S2607 (step S2613), and it further iterates the processing for all the documents in the group of documents inputted at step S2601 (step S2614).

Following step S2614, edit means 108 obtains the maximum value (S_max) from the individual degrees of similarity S_i temporarily stored at step S2612 (step S2615).

Subsequently, if the maximum value (S_max) is less than a predetermined threshold value (S_lim) (“No” at step S2616), edit means 108 deletes the value of the corresponding component part of the template as copied in the buffer (step S2617). In contrast, if the maximum value (S_max) is equal to, at least, the threshold value (S_lim) (“Yes” at step S2616), edit means 108 selects the component maximizing the degree of similarity S_i, from the components in the documents (step S2618), and it substitutes the value of the corresponding component part of the template as copied in the buffer, by the selected component (step S2619).

Next, edit means 108 iterates the processing of steps S2603-S2619 for all the components which are included in the template inputted at step S2602 (step S2620).

The template in the buffer, as has properly undergone the substitution process owing to the above process flow, is outputted as an edited result (step S2621). Then, the processing is ended.

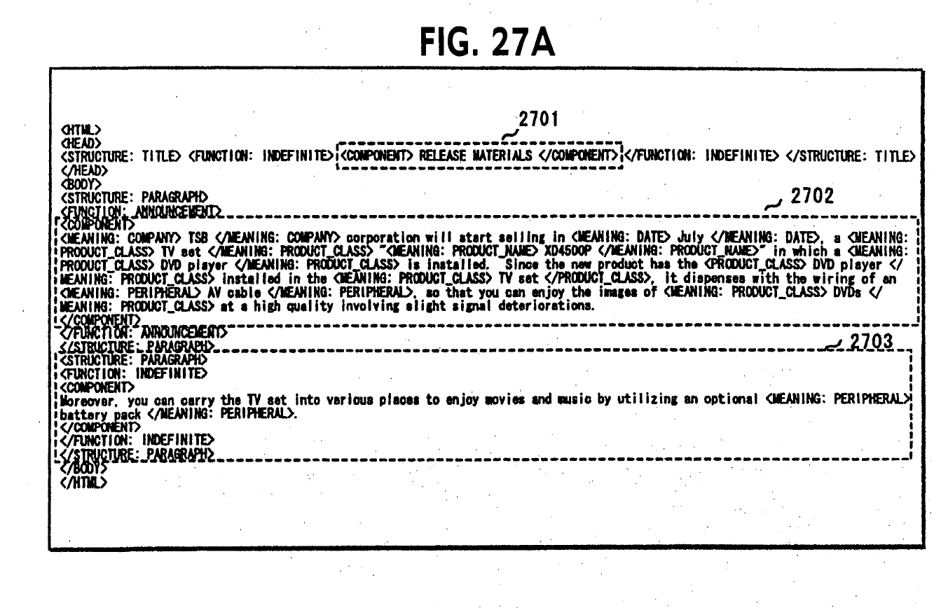

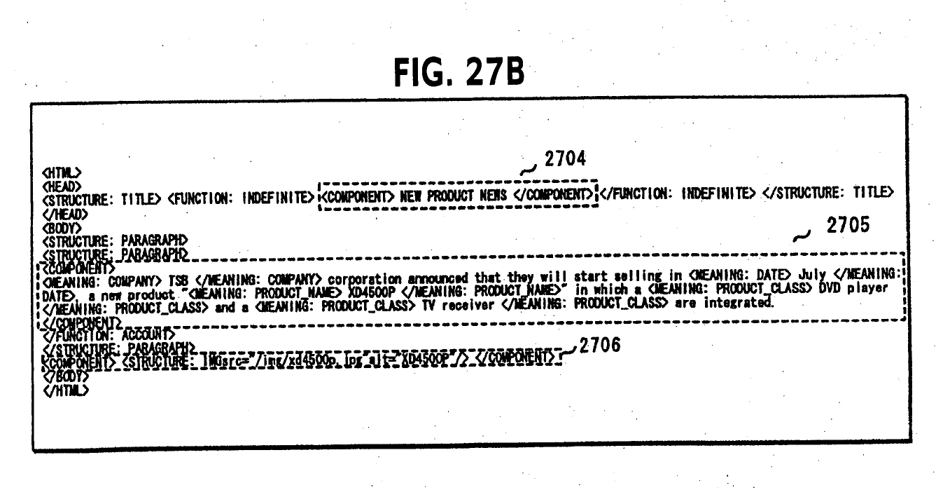

Let's consider a case, for example, where the template shown in FIG. 25 has been designated and where data in FIGS. 27A and 27B has been inputted as a group of documents.

Regarding the part of the template as indicated at reference numeral 2501 in FIG. 25, the vectors are as follows:
v_{—}1=(1, 0, 0, 0, 0)
v_{—}2=(0, 1, 0, 0)
v_{—}3=(1, 0, 1, 1, 0, 1, 0, 0, 0, 0, 0, 0, 0, 0, 0)

Regarding respective parts indicated at reference numerals 2701-2706 in FIGS. 27A and 27B, the vectors are as follows:

Part 2701:
v_{—}1′=(0, 0, 1, 0, 0)
v_{—}2′=(1, 0, 0, 0)
v_{—}3′=(0, 0, 0, 0, 0, 0, 0, 0, 0, 0, 0, 0, 0, 0, 0)

Part 2702:
v_{—}1′=(1, 0, 0, 0, 0)
v_{—}2′=(0, 1, 0, 0)
v_{—}3′=(1, 0, 1, 1, 0, 1, 0, 0, 0, 0, 0, 0, 0, 0, 0)

Part 2703:
v_{—}1′=(1, 0, 0, 0, 0)
v_{—}2′=(1, 0, 0, 0)
v_{—}3′=(0, 0, 0, 0, 0, 0, 0, 0, 0, 0, 0, 0, 0, 0, 1)

Part 2704:
v_{—}1′=(0, 0, 1, 0, 0)
v_{—}2′=(1, 0, 0, 0)
v_{—}3′=(0, 0, 0, 0, 0, 0, 0, 0, 0, 0, 0, 0, 0, 0, 0)

Part 2705:
v_{—}1′=(1, 0, 0, 0, 0)
v_{—}2′=(0, 0, 1, 0)
v_{—}3′=(1, 0, 1, 1, 0, 0, 0, 0, 0, 0, 0, 0, 0, 0)

Part 2706:
v_{—}1′=(0, 0, 0, 0, 1)
v_{—}2′=(0, 0, 0, 0)
v_{—}3′=(0, 0, 0, 0, 0, 0, 0, 0, 0, 0, 0, 0, 0, 0, 0)

Accordingly, the degrees of similarity to part 2501 are respectively computed as follows:
Part 2701:S_i=0
Part 2702:S_i=6
Part 2703:S_i=1
Part 2704:S_i=0
Part 2705:S_i=5
Part 2706:S_i=0

Therefore, the degree of similarity becomes the maximum at part 2702. If the threshold value S_max is equal to, at most, 5, part 2501 of the template in FIG. 25 is substituted by part 2702.

This example indicates that parts 2702 and 2705 are equivalent to part 2501 as the semantic attribute vectors, but that part 2702 is selected as a more appropriate component on account of the difference of the functional role vectors.

Likewise, regarding the vectors of a part indicated at reference numeral 2502:
v_{—}1=(0, 0, 0, 0, 1)
v_{—}2=(0, 0, 0, 0)
v_{—}3=(0, 0, 0, 0, 0, 0, 0, 0, 0, 0, 0, 0, 0, 0, 0)

the degrees of similarity become:
Part 2701:S_i=0
Part 2702:S_i=0
Part 2703:S_i=0
Part 2704:S_i=0
Part 2705:S_i=0
Part 2706:S_i=1

Therefore, the degree of similarity becomes maximum at part 2706. If the threshold value S_max is “0”, part 2502 of the template in FIG. 25 is substituted by the part 2706.

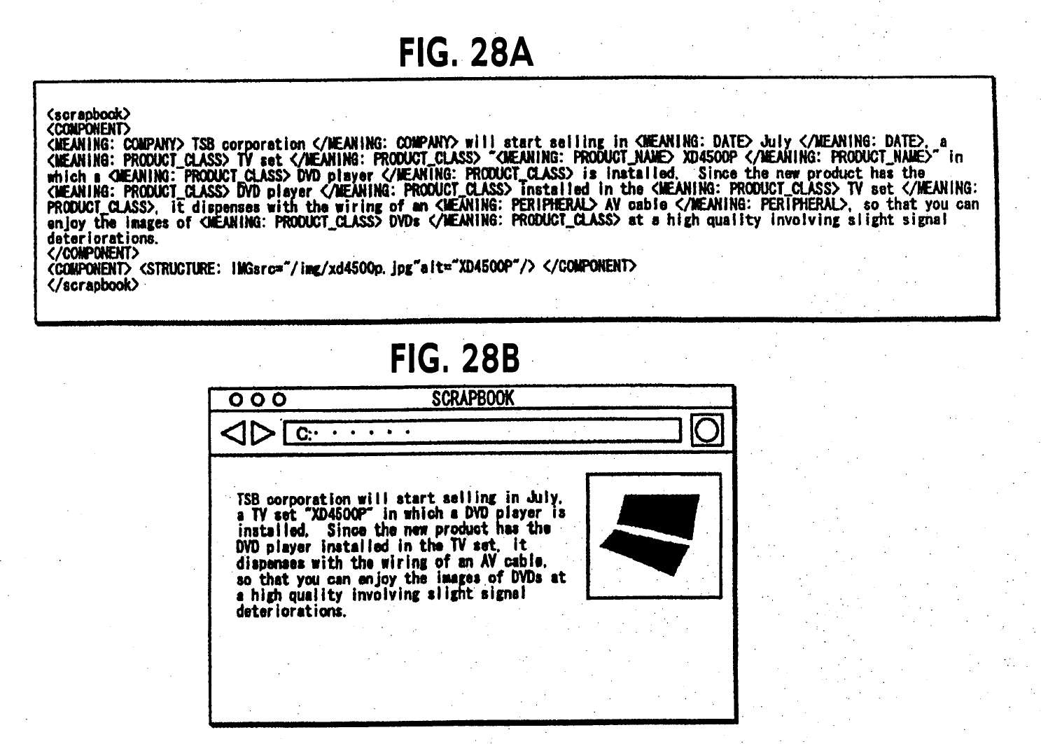

Assuming here that both parts 2501 and 2502 have been substituted, an edited result becomes as shown in FIG. 28A. FIG. 28B shows an example in which the edited result is displayed by a browser.

As described above, according to this invention, it is possible to provide the document information processing apparatus which has, in addition to the advantages of the first embodiment, the advantage that scraps to be added to a produced scrap page can be easily collected. That is, the user can very conveniently produce a scrap page similar to a template again. In accordance with the flow of FIG. 26 by way of example, edit means 108 can automatically execute an edit process on the basis of a template stored in the template storage means 2102.

Moreover, the template of a scrap page is generated from the combination of scrap components in a produced scrap page. It is therefore possible to provide the document information processing apparatus with which, in a case where the user is to produce a similar scrap page again, the user can easily produce the scrap page in accordance with the template.

The document information processing apparatus of this invention may be embodied as a program which is activated by a computer such as work station (WS) or personal computer (PC).

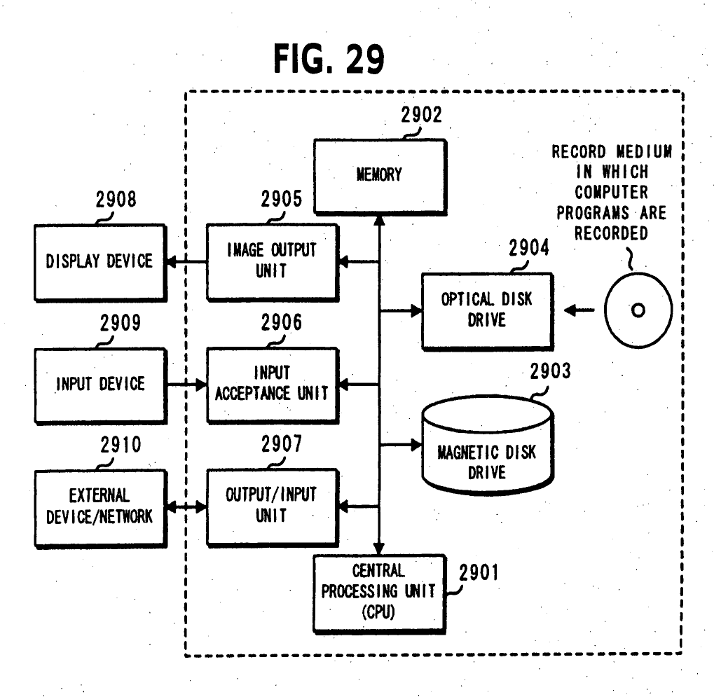

FIG. 29 shows a diagram depicting an exemplary computer in which systems and methods consistent with the present invention may be implemented. The computer includes a central processing unit 2901 which executes the program, memory 2902 in which the program and data being processed by the program are stored, a magnetic disk drive 2903 in which the program, data to be searched and an OS (Operating System) are stored, and an optical disk drive 2904 by which programs and data are read from and written to an optical disk.

Further, the computer includes an image output unit 2905 which is an interface to display a screen on a display device or the like, an input acceptance unit 2906 which accepts input from a keyboard, a mouse, a touch panel or the like, and an output/input unit 2907 which is an interface (for example, a USB (Universal Serial Bus) or an audio output terminal) for delivering output to or receiving input from an external device. Besides, the document information processing apparatus includes a display device 2908, such as an LCD, a CRT or a projector, an input device 2909 such as a keyboard or a mouse, and an external device 2910 such as a memory card reader or a loudspeaker.

Central processing unit 2901 reads the program from the magnetic disk drive 2903 and stores the program in memory 2902, and it thereafter runs the program, thereby to incarnate the individual functional blocks shown in FIG. 1. During the run of the program, some or all of the data to-be-searched may be read from magnetic disk drive 2903 and stored in memory 2902.

As basic operations, a retrieval request made by a user is accepted through input device 2909, and the data to-be-searched stored in magnetic disk drive 2903 and memory 2902 are searched in compliance with the retrieval request. Furthermore, a retrieved result is displayed on display device 2908.

The retrieved result which is displayed on display device 2908 may well be further presented to the user by voice via the loudspeaker that is connected as external device 2910, by way of example. Alternatively, the retrieved result may well be presented as printed matter via a printer that is connected as external device 2910.

The present invention is not restricted to the embodiments as they are, but it can be finalized at the stage of performance by modifying constituent elements within a scope not departing from the purport thereof. Moreover, various novel techniques can be formed by appropriately combining the plurality of constituent elements disclosed in the embodiments. By way of example, some constituent elements may well be omitted from among all the constituent elements indicated in the embodiments. Furthermore, the constituent elements in the different embodiments may well be appropriately combined.

What is claimed is:

1. A document information processing apparatus, comprising:
document information input means for inputting document information;
document analysis means for conducting a document analysis of the document information by using analytical knowledge for analyzing the document information;
componentization means for dividing the document information into information components which are units of editing;
indexing means for generating index information for the information components and assigning the index information to the information components, based on results of the document analysis; and
information component storage means for associatively storing the information components and the index information assigned to the information components.

2. A document information processing apparatus, comprising:
document information input means for inputting document information;
document analysis means for conducting a document analysis of the document information by using analytical knowledge for analyzing the document information;
componentization means for dividing the document information into information components which are units of editing;
information component selection means for allowing a user to select the information components;
indexing means for generating index information for the information components and for assigning the index information to the information components based on results of the user selection; and
information component storage means for associatively storing the information components and the index information assigned to the information components.

3. A document information processing apparatus as defined in either of claims 1 and 2, further comprising information component retrieval means for retrieving the information components from the information component storage means.

4. A document information processing apparatus as defined in either of claims 1 and 2, wherein the document analysis means conducts the document analysis of at least one member selected from the group consisting of (1) document structures of the document information, (2) functional roles of parts included in the document information, and (3) semantic attributes of any of words, clauses and sentences included in the document information.

5. A document information processing apparatus as defined in either of claims 1 and 2, wherein the document analysis means conducts a semantic analysis of the document information by using semantic analysis knowledge.

6. A document information processing apparatus as defined in either of claims 1 and 2, wherein the componentization means divides the document information into the information components based on results of the document analysis.

7. A document information processing apparatus as defined in either of claims 1 and 2, further comprising:
edit template storage means for storing edit templates which are used for editing of the information components; and
edit means for editing the information components based on at least one of the edit templates, results of the document analysis, and the results of the division by the componentization means, thereby to generate new document information.

8. A document information processing apparatus as defined in claim 7, further comprising edit template generation means for generating an edit template based on the results of the document analysis and contents of the editing by the edit means.

9. A document information processing apparatus as defined in claim 8, further comprising control means for storing, in the edit template storage means, the edit template generated by the edit template generation means.

10. A document information processing apparatus as defined in either of claims 1 and 2, further comprising document-analysis-knowledge storage means for storing results of the document analysis results.

11. A document information processing method, comprising the steps of:
inputting document information;
conducting a document analysis of the inputted document information by using analytical knowledge for analyzing the document information;
dividing the inputted document information into information components which are units of editing;
generating index information for the information components and assigning the index information to the information components based on results of the document analysis; and
associatively storing the information components and the index information assigned to the information components, as sets in information component storage means.

12. A document information processing method, comprising the steps of:
inputting document information;
conducting a document analysis of the inputted document information by using analytical knowledge for analyzing the document information;
dividing the inputted document information into information components which are units of editing;
allowing a user to select the divided information components;
generating index information for the information components and assigning the index information to the information components based on results of the user selection; and
associatively storing the information components and the index information assigned to the information components, as sets in information component storage means.

13. A computer-readable medium containing instructions for performing a method for processing document information, the method comprising:
inputting document information;
conducting a document analysis of the inputted document information by using analytical knowledge for analyzing the document information;
dividing the inputted document information into information components that are units of editing;
generating index information for the information components and assign the index information to the information components based on results of the document analysis; and
associatively storing the information components and the index information assigned to the information components, as sets in information component storage means.

14. A computer-readable medium containing instructions for performing a method for processing document information, the method comprising:
inputting document information;
conducting a document analysis of the inputted document information by using analytical knowledge for analyzing the document information;
dividing the inputted document information into information components which are units of editing;
allowing a user to select the divided information components;
generating index information for the information components and assigning the index information to the information components based on results of the user selection; and
associatively storing the information components and the index information assigned to the information components, as sets in information component storage means.
